(19) United States
(12) Patent Application Publication
(10) Pub. No.: US 2009/0099784 A1
(43) Pub. Date: Apr. 16, 2009

(54) SOFTWARE ASSISTED METHODS FOR PROBING THE BIOCHEMICAL BASIS OF BIOLOGICAL STATES

(76) Inventors: William M. Ladd, Cambridge, MA (US); Keith O. Elliston, Sudbury, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/237,566

(22) Filed: Sep. 25, 2008

Related U.S. Application Data
(60) Provisional application No. 60/995,296, filed on Sep. 26, 2007.

(51) Int. Cl. G06F 19/00

(52) U.S. Cl. 702/19

(57) ABSTRACT

The present invention relates to computational methods, systems and apparatus useful in the identification of similarities and/or differences between a plurality of biological states, such as altered biological states in an animal (e.g., a mammal or human). Particularly, the invention relates to comparing two or more causal system models (“CSMs”) which each are indicative of a biological state, such as a disease state, a toxic state, or a drug- or therapy-induced state. The present invention also relates to generating a general CSM from a comparison of two or more other CSMs, and subsequently comparing one or more of the other CSMs to the general CSM. Either of these techniques, or a combination of the two techniques, can be used to identify unique and common features in each CSM.

### RELATED APPLICATIONS

This application claims the benefit of and priority to U.S. Provisional Patent Application Ser. No. 60/995,296, filed Sep. 26, 2007, the entire disclosure of which is incorporated by reference herein.

### TECHNICAL FIELD

The present invention relates to computational methods, systems and apparatus useful in the identification of biochemical similarities and/or differences between a plurality of biological states, such as altered biological states in an animal (e.g., a mammal or human). Particularly, the invention relates to comparing two or more causal system models (“CSMs”) which each are indicative of a biological state, such as a disease state, a toxic state, or a drug- or therapy-induced state. A CSM is a computer-generated model used to describe differences between two biological states. For example, a CSM can describe the biological network(s) activated in a biological system (e.g., cell, tissue, organ, individual, and/or species) after administration of a particular drug (drug-induced biological state), relative to the state of no drug administration. The present invention also relates to generating a general CSM from a comparison of two or more other CSMs, and subsequently comparing one or more of the CSMs to the general CSM. Either of these techniques, or a combination, can be used to identify unique and/or common features in each CSM, which may indicate unique and/or common features in a corresponding biological state, and suggest candidate molecular entities and/or experiments to assess the reality of the unique and/or common features of a biological state.

CSM features can be described as nodes and connections or links. Nodes represent differences in biological entities, actions, functional activities or concepts relative to a second (e.g., reference or control) biological state. CSMs also comprise connections or links between those nodes. At least some of the links indicate causality. In a “general” CSM, nodes and links can represent these features from more than one CSM. Depending on the causal system models compared, the methods permit one to examine various biological phenomena at a systems level, for example, biological similarities and/or differences between two or more diseases and/or general toxicities; the effects of two or more administered drugs (i.e. molecular entities) or therapies; a disease and the effects of administration of a molecular entity; the effects of administration of an efficacious molecular entity and a toxic molecular entity; and/or a molecular entity administered efficaciously and the molecular entity administered in such a way as to produce toxicity.

The methods comprise an extension or improvement on the subject matter claimed in copending U.S. application Ser. No. 11/390,496 filed Mar. 27, 2006 (U.S. patent application Publication Number US2007-0225956A1). That application, entitled “Causal Analysis in Complex Biological Systems,” discloses methods for analyzing causal implications in complex biological networks, and computational methods, systems and apparatus for determining which of a multitude of possible hypotheses explanatory of an observed or hypothesized biological effect is most likely to be correct, i.e., most likely to conform with the reality of the biology under study. Thus, that application discloses the nature of CSMs, and how to make and use them. This application discloses a new use for such CSMs.

### BACKGROUND

The amount of biological information currently generated per unit time is increasing dramatically. It is estimated that the amount of information now doubles every four to five years. Because of the large amount of information that must be processed and analyzed, traditional methods of analyzing and understanding the meaning of information in the life sciences are breaking down. Statistical techniques, while useful, do not provide a biologically motivated explanation of function. There are ongoing attempts to produce electronic models of biological systems designed to facilitate biological analysis.

These ongoing attempts involve compilation and organization of enormous amounts of data, and construction of systems that can operate on the data to simulate the behavior of a biological system. Because of the complexity of biology, and the sheer numbers of data, the construction of such a system can take hundreds of man years and multiple tens of millions of dollars. Those seeking new insights and new knowledge in the life sciences are presented with the ever more difficult task of selecting the right data.

One approach has been to use causal system models (“CSM”). A CSM is a data set that represents a biological network associated with a biological state relative to a second biological state. Specifically, the CSM identifies the biological components in a biological state, for example an altered biological state (e.g., a disease state or drug-induced state), relative to a second biological state, for example, a reference biological state (e.g., a healthy state or non-drug-induced state), the reactions between at least some of those components, and the differences in at least some of those components. A CSM is a systems biology model that generally can be understood as a best-fit match between a data set, such as data derived from wet biology experiments on animals in an altered biological state relative to control animals, and a knowledge base of information that includes a vast amount of known biological data. The data derived from the wet biology experiments can include, for example, biomolecular presence, absence, increase in concentration, decrease in concentration, alteration to another form, activity, etc. The known biological data can include, for example, data from public or private biology-related databases, data from relevant journal articles, etc. The best fit match between the data sets can be achieved with methods described herein and elsewhere, and can produce a robust virtual model—a CSM—of the altered biological state. Accordingly, the biological state that is modeled by a CSM can be described as the one or more networks that are different between a specific biological system of interest (e.g., a system having disease, suffering toxicity, and/or exposed to a compound) and a second state which may be a reference or control (e.g., a healthy system, a system in homeostasis, and/or a diseased system before being exposed to a compound).

A CSM includes nodes representative of differences in plural biological entities, actions, functional activities, or concepts that are present in a biological state. A node can represent any molecule from the multiple levels of molecular biology, e.g., the polynucleotide (DNA or RNA), polypeptide, and metabolite levels, of the biological system under study, e.g., an animal, a mammal, a human, or a biological system within an animal, mammal or human. CSMs also include links between nodes, at least some of which indicate causal directionality between the nodes.

One useful development in this area is disclosed in co-pending U.S. application Ser. No. 10/644,582 filed Aug. 20, 2003 (U.S. patent application Publication Number US2005-0038608A1) and entitled “System, Method and Apparatus for Assembling and Mining Life Science Data.” That application discloses and enables exploitation of a new paradigm for the recording, organization, access, and application of life science data. The method and program enable establishment and ongoing development of a systematic, ontologically consistent, flexible, optimally accessible, evolving, organic life science knowledge base which can store biological information of many different types, from many different sources, and represent many types of relationships within the life science information. Furthermore, the knowledge base places life science information into a form that exposes the relationships within the information, facilitates efficient knowledge mining, and makes the information more readily comprehensible and available. This knowledge base is structured as a multiplicity of nodes indicative of life science knowledge using a life science taxonomy. Relationship descriptors are assigned to pairs of nodes that correspond to a relationship between the pair, and may themselves comprise nodes. A very large number of nodes are assembled to form an electronic knowledge base, such that every node is joined to at least one other node. It was envisioned that the knowledge base could eventually incorporate the entirety of human life science knowledge from its finest detail to its global effect, and incorporate an endless diversity of biological relationships in thousands of other organisms. Such a life science knowledge base can be used in a manner similar to a library, permitting researchers, physicians, students, drug discovery companies, and many others to access life science information in a way that enhances the understanding of the information, but is far more powerful as a research resource. Small portions of the knowledge base may be represented graphically as a web of interrelated nodes, but for any significantly biological system, these are beyond rational comprehension because of their complexity.

A second valuable development came from the realization that querying this knowledge base in its holistic form to determine cause and effect relationships in a particular biological space was sometimes cumbersome, as the knowledge base included vast amounts of data wholly unrelated to the space under investigation. This led to development of a second invention disclosed and claimed in co-pending U.S. application Ser. No. 10/794,407, filed Mar. 5, 2004 (U.S. patent application Publication Number US2005-0154535A1) and entitled “Method, System and Apparatus for Assembling and Using Biological Knowledge.” That application discloses and enables production of sub-knowledge bases and derived knowledge bases (called “assemblies”) from a global knowledge base by extracting a potentially relevant subset of life science-related data satisfying criteria specified by a user as a starting point, and reassembling a specially focused knowledge base. These then are refined and augmented, and then may be probed, displayed in various formats, and mined using human observation and analysis and using a variety of tools to facilitate understanding and revelation of hidden or subtle interactions and relationships in the biological system they represent, i.e., to produce new biological knowledge.

Another valuable group of inventions are disclosed and claimed in co-pending U.S. application Ser. No. 10/992,973, filed Nov. 19, 2004 (U.S. patent application Publication Number US2005-0165594) and entitled “System, Method, and Apparatus for Causal Implication Analysis in Biological Networks.” That application discloses a group of tools for use with the global knowledge base or with an assembly which facilitate hypothesis generation. The tools and methods perform logical simulations within a biological knowledge base and permit more efficient execution of discovery projects in the life sciences-related fields. Logical simulation resembles reasoning in many respects and includes backward logical simulations upstream of cause and effect relationships, which proceeds from a selected node upstream through a path, typically comprising multiple branches, of relationship descriptor nodes to discern a node or group of nodes representing a biomolecule or activity which is hypothetically responsible for an experimentally observed or hypothesized change in the biological system. In short, this type of computation answers the question “What could have caused the observed change?” Logical simulation also includes forward simulations, downstream of cause and effect relationships, which travel from a target node downstream through a path of relationship descriptors to discern the extent to which a perturbation of the target node causes experimentally observed or hypothetical changes in the biological system. The logical simulation travels through a path of relationship descriptors containing at least one potentially causative node or at least one potential effector node to discern a pathway hypothetically linking the target nodes. This in turn permits the generation of new hypotheses concerning biological pathways based on the biological knowledge, and permits the user to design and conduct biological experiments involving biomolecules, cells, animal models, or a clinical trial to validate or refute a hypothesis. The set of these paths comprise explanations for perturbations of the target nodes which hypothetically can be caused by perturbations of the source nodes. The perturbation is induced, for example, by a disease, toxicity, drug reaction, environmental exposure, abnormality, morbidity, aging, or another stimulus.

When an investigation is based on a hypothesized relationship or on an experimentally observed relationship between distinct biological elements, and the goal is to understand the underlying biochemistry and molecular biology causative of the relationship, it often will be the case that numerous potentially explanatory paths will emerge from an in silico analysis. Thus, the foregoing and potentially other related software based biological system analysis techniques can result in a large number of hypotheses including hypotheses that are mutually exclusive, and many which may in fact not be representative of real biology. This is not surprising in view of the extreme complexity of biological systems.

A method utilizing the foregoing technology in a novel way to conduct causal analysis in complex biological systems is disclosed and claimed in copending U.S. application Ser. No. 11/390,496, filed Mar. 27, 2006 (U.S. patent application Publication Number US2007-0225956A1) and entitled “Causal Analysis in Complex Biological Systems.” That application provides software implemented methods of discovering active causative relationships in the biology, e.g., molecular biology, of complex living systems. The method is practiced within the domain of systems biology and is designed to discover the web of interactions of specific biological elements and activities causative of a given biological response or state. It may be practiced using a suitably programmed general purpose computer having access to a biological data base of the type disclosed herein.

The problem solved by this method may be analogized to the task of finding the right networks within a vast, multi dimensional array or web of selectively interconnected points respectively representing something about a biological molecule or structure, its various activities, its structural variants, and its various relationships with other points to which it connects. A connection indicates that there is a relationship between the two points and optionally the directionality of the relationship, e.g., the node “kinase activity of protein P” might be linked to “quantity of phosphorylated form of protein S,” protein P's substrate, by indicia of directionality, indicating node “kaProtP” influences “PhosProtS,” and not vice versa. Suppose also that from observation, it is known that when drug A is administered, it inhibits protein T, and induces a given biological state or states in the organism, e.g., reduced secretion of stomach acid, and in some subjects, induces the onset of inflammatory bowel disease. The question: “what is the mechanism of the effects?” involves finding the specific networks within this vast network of connected points that best explain the data, and are most likely to represent real biology. There may be thousands or millions of potential such pathways in a knowledge base, and a large number even in a well targeted assembly.

Generally, the method of the '496 application comprises mapping operational data onto a knowledge base, preferably an assembly, of the type described therein to produce a large number of models—chains defining branching paths of causality propagated virtually through the knowledge base—and applying a series of algorithms to reject, based on various criteria, all or portions of the models judged not to be representative of real biology. This pruning or winnowing process ultimately can result in one or a small number of models which underlie an explanation of the operational data, i.e., reveals causative relationships that can be verified or refuted by experiment and can lead to new biological knowledge.

The method comprises the steps of first providing a knowledge base of biological assertions concerning a selected biological system. The knowledge base comprises a multiplicity of nodes representative of a network of biological entities, actions, functional activities, and biological concepts, and links between nodes indicative of there being a relationship therebetween, at least some of which include indicia of causal directionality. The knowledge base of the above mentioned '582 application; or preferably an assembly of the type disclosed in the above mentioned '407 application targeted to the selected biological system, are examples of such knowledge bases.

The purpose of the system is to aid in the understanding of the biochemical mechanisms explanatory of a data set, herein referred to as “operational data.” Operational data is data representative of a perturbation of a biological system, or characteristic of a biological system in a particular biological state, and comprises observed changes (observational data) in levels or states of biological components represented by one or more nodes, and optionally hypothesized changes (hypothetical data) in other nodes resulting from the perturbation(s). The operational data can comprise an effective increase or decrease in concentration or number of a biological element, stimulation or inhibition of activity of an element, alterations in the structure of an element, the appearance or disappearance of an element or phenotype, or the presence or absence of a SNP or allelic variant of a protein. Typically, the operational data is experimentally determined data, i.e., is generated from “wet biology” experiments. Preferably, all of the biological elements recorded as increasing or decreasing, etc., in the operational data are represented in the knowledge base or assembly.

Thus plural models or chains, i.e., paths along connections or links and through nodes within the data base, are identified by software. This typically is done by simulating in the network one or more perturbations of multiple individual root nodes (or starting point nodes) to initiate a cascade of activity through the relationship links along connected nodes preferably to an intermediate or most preferably a terminal node that is representative of a biological element or activity in the operational data. This process produces plural (often 104, 105 or more) branching paths within the knowledge base potentially individually representing at least some portion of the biochemistry of the selected biological system.

These branching paths constituting models are prioritized by applying algorithms to the models which estimate how well each model predicts the operational data. This is done by mapping the operational data onto each candidate model and counting the number of nodes in the model that are representative of, and/or correspond to, elements represented in the operational data.

This results in definition of a smaller set of branching paths comprising hypotheses potentially explanatory of the molecular biology implied by the data. Typically, after such a screening via the mapping algorithm(s), there still are many such branching paths, often hundreds or thousands, depending on the granularity of the assembly or of the knowledge base, on the question in focus, on the prioritization criteria, and on other factors.

The foregoing steps of generating, mapping and prioritizing pathways can be conducted in any order. For example, the software may first map the operational data onto the assembly, then search for branching paths and keep a ranking based on the amount of data correctly simulated, or it may be designed to first identify all possible paths involving a given data point, then map remaining data onto each path and prioritize as mapping proceeds, etc. Preferably, for efficiency, some or all of the operational data is mapped onto the knowledge base or assembly before raw path finding commences, and the paths discerned are constrained to paths which intersect a node corresponding to or at least involved with the data.

A large number of hypotheses may be identified, each of which potentially explains at least some portion of the operational data. Accordingly, another step in creating a causal system model is to apply logic based criteria to each member of the set of models to reject paths or portions thereof as not likely representative of real biology. This “hypothesis pruning” leaves one or a small number of remaining models constituting one or more new active causative relationships. A step may be used to harmonize a plurality of remaining paths to produce a larger path, to select a subgroup of paths, or to select an individual path comprising a model of a portion of the operation of a the biological system. “Harmonizing” means that plural branching paths are combined to provide a more complete or more accurate model explanatory of the operational data, or that all branching paths except one are eliminated from further consideration. In addition, a step of simulating operation of the model may be used to make predictions about the selected biological system, for example, to select biomarkers characteristic of a biological state of the selected biological system, or to define one or more biological entities for drug modulation of the system.

The method can be practiced by applying a plurality of logic based criteria to the set of branching paths to approach one or more hypotheses representative of real biology. This approach may employ a scoring system based on multiple criteria indicative of how close a given hypothesis/branching path approaches explanation of the operational data. Collectively, the various features of the hypothesis pruning protocols enable identification of one or more hypotheses which approach known aspects of the biology of the selected biological system and the biological change under study.

The result of this exercise is a collection of connected nodes herein referred to as a “causal system model” or “CSM.” A causal model system or CSM can also be referred to as a “causal network model” or “CNM.”

### SUMMARY OF THE INVENTION

The present invention relates to a software assisted method for identifying similarities and differences between the biochemistry of a plurality of biological states. In one aspect, the method includes providing in a storage medium a plurality of causal system models, each of which represent a biological state in an animal. Each causal system model includes nodes representative of differences in plural biological entities, actions, functional activities, or concepts in one of the biological states as compared with a second biological state, and links between the nodes indicative of there being a causal directionality between the nodes. At least a portion of at least one causal system model is compared electronically to at least a portion of at least one other casual system model to identify similarities and differences between nodes from respective model to discern biochemical similarities and differences between the modeled biological states. The biological states modeled by a causal system model include one or more biochemical or molecular biological networks that appear to be different between a specific biological system of interest (e.g., a system having disease, suffering toxicity, and/or exposed to a compound) and a second system, such as a reference or control (e.g., a healthy system, a system in homeostasis, and/or a diseased system before being exposed to a compound).

By comparing the causal system models, researchers can discern biochemical similarities and differences between the biological states modeled by the respective causal system models. An electronic representation of the biochemical similarities and differences between these biological states modeled by the respective causal system models can be stored physically on a computer-readable medium for retrieval and use by a researcher or another party (e.g., an investigator). In certain embodiments, an investigator (e.g., a pharmaceutical company) can cause one or more second party entities (e.g., a researcher, a discovery unit associated with a pharmaceutical company, or an outside contractor) to perform one or more steps of the method.

The causal systems models in the plurality can be any number. Moreover, the plurality can include both single and/or general causal system models. General causal system models include the characteristics from more than one other (single or general) causal system model. A general causal system model is a model of a generic biological state, for example, a generic toxicity or a generic efficacy. It typically is produced as disclosed herein by comparison of a plurality of causal system models where different entities or unknown factors lead to a common phenotype.

In certain embodiments, the method includes comparing one causal system model to plural other causal system models to discern the underlying biochemical network characteristic of the biological state represented by the one causal system model. In certain embodiments, the modeled biological states are selected from a disease biological state; a biological state at disease onset, at disease progression, or disease regression; a toxic biological state; a drug-treated biological state; a therapy-treated biological state; a drug- or therapy-sensitive biological state; and a drug- or therapy-resistant biological state. Certain embodiments include the additional step of suggesting or conducting a biological experiment to assess the biological reality of the similarity and/or difference between the biological states suggested by the analysis.

In another aspect, the present invention provides a software assisted method for probing the pharmacology of a molecular entity in an animal, typically a mammal, such as a human or experimental animal. Broadly, the method comprises, in one step, providing in a storage medium a plurality of causal system models. Each model comprises a collection of nodes representative of differences in plural biological entities, actions, functional activities, or concepts in one of the biological states as compared with a second biological state, and links between nodes. At least some of the links indicate a causal directionality between the nodes. Each model is representative of differences in the biochemistry and molecular biology of an animal, which are induced by administration to the animal of a selected molecular entity, a selected dose of a selected molecular entity, or a selected group of molecular entities. Then, in another step, at least two of the causal system models are electronically compared to discern biochemical differences between the biochemical effects in the animal of different molecular entities, different doses of molecular entity, or different groups of molecular entities. An electronic representation of the biochemical differences between the biochemical effects in the animal of different molecular entities, different doses of molecular entity, or different groups of molecular entities can be stored physically on a computer-readable medium for retrieval and use by the researcher or another party (e.g., an investigator). In certain embodiments, an investigator (e.g., a pharmaceutical company) can cause one or more second party entities (e.g., a researcher, a discovery unit associated with a pharmaceutical company, or an outside contractor) to perform one or more steps of the method.

In certain embodiments, the method can include the additional step of suggesting a molecular entity for development, or conducting experiments with such a selected molecular entity.

In some embodiments, the method includes probing the efficacy of a molecular entity to induce a desired biological effect by comparing a causal system model of the biochemical effects of the entity to a causal system model of the biochemical effects of one or more different molecular entities which induce the same or a related biological effect.

In some embodiments, the method includes probing the toxicology of a molecular entity by comparing causal system models of the biochemical effects of a plurality of different molecular entities directed to the same target. In some embodiments, the method includes probing the toxicology of a molecular entity by comparing a causal system model of the effects of administration to a mammal of the molecular entity to plural causal system models of toxic responses.

In some embodiments, the method includes probing the on target toxic effect associated with agonizing or antagonizing a preselected target with a molecular entity by comparing a causal system model of the biological effect of agonizing or antagonizing the target to a causal system model of a toxicity.

In some embodiments, the method includes probing the off target toxic effect associated with agonizing or antagonizing a preselected target with a preselected molecular entity by comparing a causal system model of the biological effect of agonizing or antagonizing the target with the entity to a causal system model of a toxicity.

In some embodiments, the method includes probing the off-target toxic effect associated with agonizing or antagonizing a preselected target by comparing a causal system model of the biological effect of agonizing or antagonizing the target with a molecular entity to a causal system model of the biological effects of a known molecular entity known to elicit a toxicity or efficacy.

The plurality of causal system models being compared can comprise models of toxicities generated from publicly available data descriptive of the biochemistry of toxicities relating to the function of the heart, liver, kidney, nervous system, circulatory system, respiratory system, or immune system. The causal system models being compared can be generated from data from different species. The biological state being modeled by a causal system model can be a toxic state or a drug-induced state.

The causal system models may be generated by a method comprising providing a knowledge base of biological assertions concerning a selected biological state, the knowledge base comprising a network of a multiplicity of nodes representative of a biological entities, actions, functional activities, and concepts, and links between nodes. The links indicate a relationship between the nodes, and at least some of the links include indicia of causal directionality between the nodes. In another step, one or more perturbations of plural individual root nodes is simulated in the network to initiate a cascade of virtual activity through the links between connected nodes to discern multiple branching paths within the knowledge base. In another step, operational data (e.g., observational data) representative of a perturbation, associated with a biological state, of one or more nodes and optionally of experimentally observed or hypothesized changes in other nodes resulting from the one or more perturbations is mapped onto the knowledge base. In another step, the branching paths are prioritized on the basis of how well they predict the operational data, thereby to define a set of models comprising the branching paths potentially explanatory of the molecular biology implied by the data. In another step, the logic based criteria is applied to the set of models to reject models as not likely representative of real biology thereby to eliminate hypotheses and to identify from remaining models one or more causative relationships. The method for generating causal system models can include the additional step of harmonizing a plurality of the remaining models to produce a larger model comprising a model of at least a portion of the operation of the biological system.

One or more of the logic based criterion can be based on a measure of consistency between (1) the predictions resulting from simulation along multiple nodes of a model and known biology of the selected biological system; (2) the operational data and the predictions resulting from simulation within a model upstream from a root node to a node corresponding to an operational data point; and/or (3) the operational data and the predictions resulting from simulation within a model downstream from a root node to a node corresponding to an operational data point.

The method for generating the models can include providing the knowledge base by providing a knowledge base of biological assertions comprising a multiplicity of nodes representative of biological elements and descriptors characterizing the elements or relationships among nodes; extracting a subset of assertions from the knowledge base that satisfy a set of biological criteria specified by a user to define a selected biological system; and compiling the extracted assertions to produce an assembly comprising a biological knowledge base of assertions potentially relevant to the selected biological system.

The operational data may include observational data indicative of an effective increase or decrease in concentration or number of a biological element, stimulation or inhibition of activity of an element, differences in the structure of an element, the presence or absence of an element, or the appearance or disappearance of an element. In a preferred method for generating the models, the operational data is experimentally determined data.

Biomolecules which can constitute components of the profile include proteins, (including allelic variants) RNAs, DNAs and particular single nucleotide polymorphisms, metabolites, lipids, sugars, xenobiotics, and various modified forms of such species.

Other aspects of the invention will be apparent from the description and claims that follow. It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### BRIEF DESCRIPTION OF THE DRAWINGS

FIG. 1 is a flow chart illustrating the structure of a data base useful in the practice of the invention.

FIG. 2 is a block diagram illustrating a sequence of steps for producing models used in one embodiment of the invention.

FIG. 3 is a graphical representation of a biochemical network embodied within a data base comprising an assembly directed toward a selected biological system (here generalized human biology). As is apparent the complexity of the system is far beyond human cognitive comprehension, and such graphical representations have limited utility.

FIG. 4 is a graphical representation of a simplified “hypothesis” (branching path or model) useful in explaining the nature of the hypotheses that are pruned to deduce a causal relationship explanatory of real biology.

FIG. 5 is a key indicating the meaning of the various symbols used in the schematic graphical representation of a branching path illustrated in FIGS. 6 through 14.

FIGS. 6-14 are illustrations of models useful in explaining the various computationally based methods of pruning candidate hypotheses.

FIG. 15 is a block diagram of an apparatus for performing the methods described herein.

FIG. 16 is a graphical illustration showing how different compounds (i.e., molecular entities), different classes of compounds, and/or competitive compounds can elicit common and different biological processes in a biological system.

FIGS. 17A-17D show graphical illustrations of CSMs of cancer, and the biological effects of three molecular entities used for the treatment of the cancer, respectively. The three compounds are described as Receptor Antagonist 1, Receptor Antagonist 2, and Receptor Antagonist 3, respectively.

FIGS. 18A and 18B graphically illustrate the union (FIG. 18A) and intersection (FIG. 18B) of the three CSMs representing biological networks activated by the Receptor Antagonist drugs described in connection with FIG. 17.

FIGS. 19A and 19B each graphically illustrate the combined union and intersection of the three CSMs described in connection with FIGS. 18A and 18B, respectively. In FIG. 19A, key on-target effects (nodes shared by all three networks in FIGS. 17B-17D) are identified by circles. In FIG. 19B, off-target effects (nodes unique to one or two networks in FIGS. 17B-17D) are identified by triangles.

FIG. 20 depicts the combination of the two graphical illustrations shown in FIGS. 19A-19B.

FIGS. 21A-21B graphically illustrate key on-target effects (circles) and potential off-target effects (triangles) in CSMs representing the biological effects of Receptor Antagonist 1 and Receptor Antagonist 2, respectively. Triangles identified by arrows identify nodes of exemplary off-target effects (i.e. mechanisms) elicited by the corresponding compounds.

FIGS. 22A-22D graphically illustrate CSMs representing the biological effects of four structurally related compounds, Compounds 1-4, on a biological system.

FIG. 23 graphically illustrates a general CSM representing the biological effects common to all compounds described in connection with FIGS. 22A-22D.

FIGS. 24A and 24B graphically illustrate the causal links unique to CSMs of Compound 4 and Compound 1, as compared to the common causal links in the general CSM depicted in FIG. 23.

### DETAILED DESCRIPTION OF THE INVENTION

The present invention represents an advance in the field of systems biology. There are two general subfields in the field of systems biology. The first subfield is data-focused and involves the development of methods and technologies that allow for the simultaneous measurement of large numbers of biomolecules within a biological system. The second subfield is model-focused and involves the development of methods and technologies to model the actions and interactions of the biomolecules within a biological system in order to understand the systematic nature of biological events. The present invention primarily falls into this second sub-field.

One type of model in systems biology is known as a causal system model (“CSM”). As used herein, a causal model system or CSM can also be referred to as a “causal network model” or “CNM.” A CSM represents biological relationships in terms of cause and effect relationships within a system, for example, in terms of A causing B. A CSM can connect many biological elements or “nodes” into a highly intricate network of relationships and/or connections to form a systematically descriptive, inclusive, and scalable representation of a biological system. See, Lieu and Elliston (2006) “Applying a Causal Framework to Systems Modeling,” Ch. 7 (pgs. 140-152) in Systems Biology: Applications and Perspectives, Ernst Schering Research Foundation Workshop 61, Springer, Bringmann et al. (eds.). The nodes in a CSM are representative of differences in plural biological entities, actions, functional activities, or concepts in a biological state as compared with a second biological state (e.g., a reference biological state). The number of nodes and/or relationships in a CSM can be any number, for example, greater than 100, greater than 1000, greater than 10,0000, greater than 100,000, or more.

The second or reference biological state used to generate nodes for a CSM will depend on the analysis being performed. For example, when generating a CSM modeling the biological networks associated with a disease or toxic state, the reference biological state may be a healthy or homeostatic biological state. When generating a CSM modeling the biological networks associated with administration of a particular compound or treatment, the reference biological state may be a disease biological state. It should be understood that a CSM is not generated for the reference biological state. Rather, the reference biological state is used to generate nodes for a CSM that models an altered biological state. Accordingly, a CSM is a model of the biomolecular basis of a given biological state relative to another biological state. For example, a CSM can model an altered biological state such as a disease state, a toxic state, or a drug- or therapy-induced state.

In addition to a disease state, a toxic state, or a drug- or therapy-induced state, a CSM can model, for example, a similar biological state in a different species; a similar biological state from a different group within a species, for example, a genetically or geographically different group within a species; a biological state elicited by exposure to one or more environmental conditions; or a biological state elicited by exposure to a medical treatment. A CSM can model a stage of disease (e.g., initiation, progression, or regression); a biological state of compound (e.g., molecular entity) or therapy sensitivity and/or resistance; and/or a state that is perturbed by any factor that causes change as compared to an initial (e.g., second or reference) biological state.

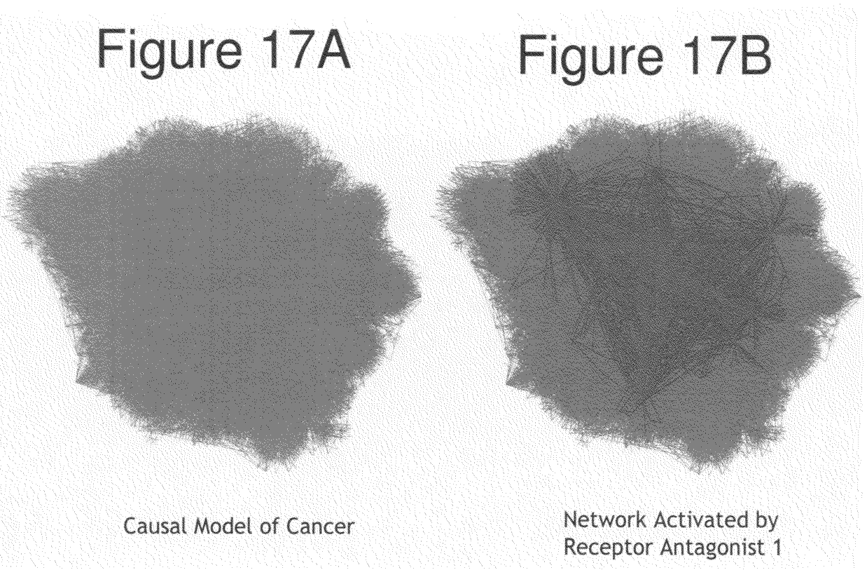

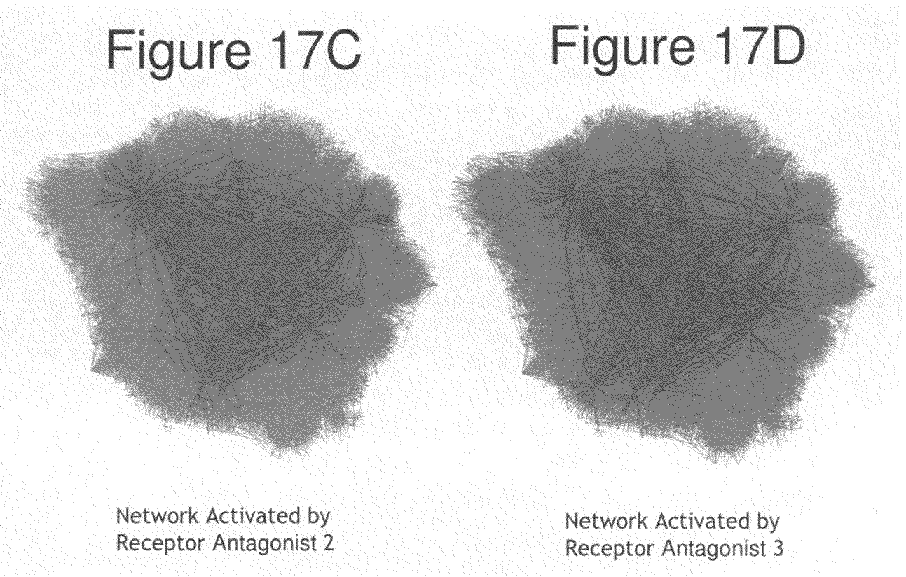

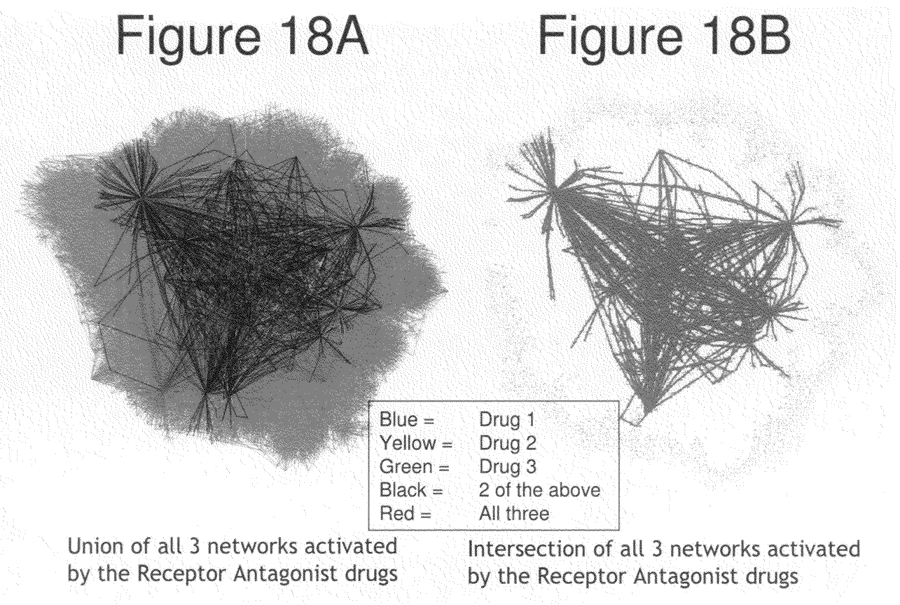

As noted above, CSMs can also include “general” CSMs, which are models of the differences in biological entities, functional activities, concepts, and/or actions that are shared by or differ among two or more biological states (e.g., by comparing CSMs of different biological states). Particularly, a general CSM can also comprise the union or intersection of other CSMs (see FIGS. 18A and 18B, discussed below). A general CSM that comprises the union of other CSMs may include all nodes and connections from the other CSMs. A general CSM that comprises the intersection of other CSMs may include only those nodes and connections common to all the CSMs included in the intersection. In this way, a general CSM can model some general biological phenomenon, such as the biological efficacy of a group of drugs or the biological mechanism(s) common to a class or type of disease. It should be understood that the term “general CSM” can be used in a relative sense. That is, a general CSM can comprise other general CSMs. For example, a general CSM modeling the active biological networks in breast cancer can be compared to a general CSM modeling the active biological networks in colon cancer to yield a general CSM of cancer (if such exists).

In the present invention, two or more CSMs are compared to analyze the similarities and/or differences in the biological states represented by the respective CSMs, and this can be done at various levels of detail, including the levels of biochemistry, molecular biology, organelle, cellular, tissue, organ, organ system, or individual. Each CSM in the comparison can model a given biological state of an organism or species. Any number of CSMs can be compared. For example, two, three, five, ten, twenty, fifty, 100, 1000, or more CSMs can be compared, so long as each CSM exhibits differences or similarities in amount, presence, and/or concentration of biomolecules or biological structures from any one or more of the corresponding biological elements in any one of more of the other CSMs in the comparison. Moreover, only a portion or portions of CSMs may be compared. Any group of compared CSMs can include any number of general CSMs.

The protocols for comparing CSMs broadly involve providing CSMs representative of biological states to be investigated and comparing those CSMs node by node to discern similarities and/or differences (e.g., patterns of similarities and/or differences or single similarities or differences between CSMs). The analytical procedures are designed to identify biochemical differences, for example, the presence of biomolecules, concentrations of biomolecules, and/or patterns of biomolecules present in one or more biological states that are identical, similar, dissimilar and/or different in one or more other biological states. Data from these comparisons can represent various biological phenomena, for example biological mechanisms associated with a disease-type or a side effect from administration of one molecular entity as compared to another. A researcher can perform the comparison using a computer with a user-interface and can physically store electronic representations of the various data (e.g., CSMs, results of comparisons, etc.) on a computer-readable medium for retrieval and use by the researcher or another party (e.g., an investigator). The stored data may be used to determine, for example, the efficacy and/or side effects of candidate molecular entities for treating a particular disease state. Moreover, these data in turn can be validated by conducting experiments designed to support or refute the model.

In practice, the comparison between CSMs identifies the nodes, or groups of the nodes, that are similar and/or different in the CSMs being compared. A user may set various criteria to identify similarities and/or differences. For example, a computer can be tasked to identify a node, or any group of nodes in different CSMs that are identical (e.g., identify all nodes in each of two CSMs that are altered in the same direction from control). It may analyze plural CSMs to rank their degree of difference or similarity and identify which portions of the network of the CSM are different.

Thresholds can be used by a computer to assess dissimilarity between nodes or groups of nodes in different CSMs. A comparison of CSMs need not include all nodes in all CSMs being compared. Rather, a CSM comparison of the present invention includes both comparisons of all nodes in each CSM being compared, as well as comparison of a portion of the nodes in some CSMs or a portion of nodes in each CSM.

Depending on the purpose of the exercise, the methods and stored data resulting therefrom permit one to examine various biological phenomena at a systems level, for example, systematic similarities and/or differences between two or more diseases and/or toxicities; between the biological effects of two or more administered molecular entities; between a general disease state or a toxic state and the biological effects of a molecular entity; between two or more toxic and/or diseased states; between an efficacious molecular entity and a toxic molecular entity; or between a molecular entity administered efficaciously and the molecular entity administered in such a way as to produce toxicity.

### I. Rationale for Causal System Models

The path to scientific advances is through iteration. Scientists design experiments to generate discrete observations (collected as data), formulate hypotheses to explain these observations, and test their theories by designing more experiments, collecting more data, refining their hypotheses and then repeating the process.

Increasingly, there is a potential obstacle impeding this cycle of scientific advancement. Namely, scientists encounter a cognitive barrier when confronted with large data sets that are far larger, often by orders of magnitude, than what humans can manageably comprehend. The natural inclination is to break the vast quantity of data into smaller manageable pieces, which can result in missing the big picture in the overall system. This is where casual modeling can produce dramatic improvements in the process. Data are transformed into computable cause and effect relationships, and artificial intelligence is used to reason through the relationships to generate millions of potential hypotheses, which are then evaluated through a number of algorithms to produce a set of statistically significant hypotheses. Casual modeling enables a rapid and iterative scientific interrogation with impossibly large amounts of information. This approach has been referred to as computer-aided biology because scientists are not presented with simply another analysis stream, but rather are enabled to systematically reason through a very large data set, using a very large knowledge base of known biology, and to produce a coherent set of experimentally testable scientific hypotheses.

Within this framework, casual modeling is consistent and compatible with the ways that humans think, and it can adapt to a scale to meet the growing pace of scientific innovation. By designing this framework to be computable, this approach to systems biology alleviates the cognitive limitations of human scientists. Human scientists are simply not able to think about hundreds of thousands of data points in the context of millions of biological facts at the same time, nor are they able to evaluate millions of potential hypotheses to define those that best fit these conditions. However, within a computable knowledge framework that represents the world of known biological facts, computer-aided causal reasoning enables every data point to be considered in the context of all known biology for development of rational, mechanistic hypotheses that represent the inner workings of biological systems.

Knowledge encapsulated within a knowledge base that supplies biological elements or nodes to a CSM is reusable. Moreover, CSMs, once generated, can be compared to find commonalities and differences that represent general biological phenomena. The commonalities can be represented in another CSM—a general CSM—and subsequently compared to individual CSMs. Specific similarities and/or differences in the individual CSM can then be identified as representative of, for example, a common mechanism of action or a novel biomolecular mechanism associated with the specific CSM.

### II. Generating a Single Causal System Model

### II.A. Overview

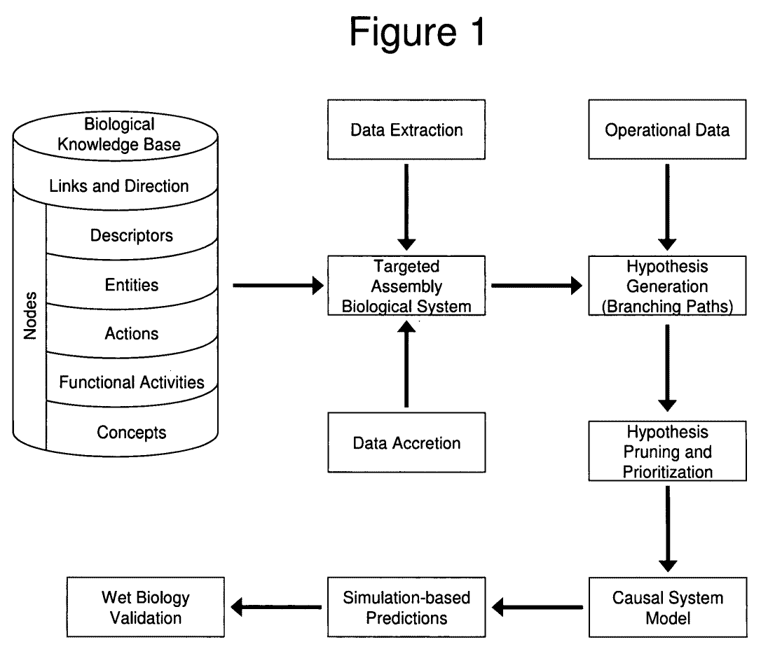

The overall logic flow of a method for preparing a causal system model (“CSM”) is shown in FIG. 1. A large reusable biological knowledge base comprises an addressable storehouse of biological information, typically stored in a memory, in the form of a multiplicity of data entries (e.g., biological elements or “nodes”) which represent 1) biological entities (biomolecules, e.g., polynucleotides, peptides, proteins, small molecules, metabolites, lipids, etc., and structures, e.g., organelles, membranes, tissues, organs, organ systems, individuals, species, or populations), 2) functional activities (e.g., binding, adherence, covalent modification, multi-molecular interactions (complexes), cleavage of a covalent bond, conversion, transport, change in state, catalysis, activation, stimulation, agonism, antagonism, repression, inhibition, expression, post-transcriptional modification, internalization, degradation, control, regulation, chemo-attraction, phosphorylation, acetylation, dephosphorylation, deacetylation, transportation, transformation, etc.), 3) biological concepts (e.g., metastasis, hyperglycemia, apoptosis, angiogenesis, inflammation, hypertension, meiosis, T-cell activation, etc.), 4) biological actions (inhibit or promote), and 5) biological descriptors (e.g., species or source designations, literature references, underlying structural information, e.g., amino acid sequence, physico-chemical descriptors, anatomical location descriptors, etc.).

Any two nodes having a known and curated physical, chemical, or biological relationship are linked. Also designated in the knowledge base is a direction of causality between a pair of nodes (if known). Thus, for example, a link between catalysis and substrate would be in the direction of the substrate; and a link between a substrate and a product in the direction of product.

Such a comprehensive knowledge base may be difficult to navigate, as it comprises thousands or millions of nodes irrelevant to any specific analysis task. It is therefore preferred to build a sub knowledge base, i.e., to develop a specialty knowledge base specifically adapted for the task at hand. This fundamentally involves extracting from the global knowledge repository, e.g., using Boolean search strategies, all nodes meeting certain user specified criteria, and configuring the extracted nodes to form a sub knowledge base. This can be augmented by, for example, adding to the sub knowledge base new nodes from the literature thought to be potentially pertinent to the topic at hand, altering the granularity of the sub knowledge base in areas of limited interest, and applying logic algorithms to fill in gaps in the paths based on analogous reasoning, extrapolating to the species under study biological paths studied in detail in a different species, etc. This forms a working knowledge base herein referred to as an “assembly.”

In the next step of the process, operational data (observed biological data from experiments or hypothetical biological data) is mapped onto the assembly, and algorithms simulate the effect through the assembly of hypothesized increases or decreases in the quantity or activity of nodes within the assembly. This results in generation of a large number of branching paths which involve nodes representative of data points in the operational data set. Some or all of these branching paths or “models” predict an increase or decrease in one or more nodes which are representative of, and preferably corresponds to, an activity or entity in the operational data set. Paths are selected and prioritized on the basis of how many operational data points are involved with the path; generally, the more operational data involved in a path, the more likely it is to be selected for further processing.

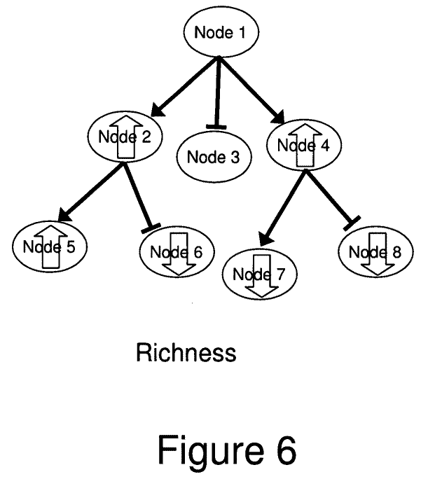

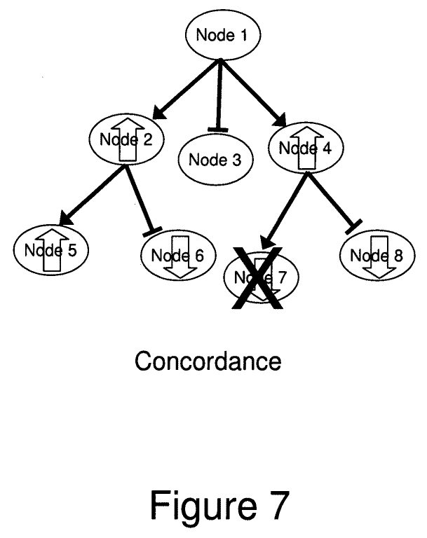

In a preferred practice, the models are evaluated for “richness” and “concordance.” Richness refers to resolution of the question whether, with respect to each model, the number of nodes in the model which map onto the data is greater than the number that would map by chance. This is done as set forth hereafter and as explained with reference to FIG. 6 and FIG. 7, and results in identification of a set of branching paths, or hypotheses, potentially explanatory of the operational data. In a given exercise, depending on the biological space under study, the data package involved, the focus of the assembly, and the stringency of the criteria, there may be thousands or hundreds of thousands of such hypotheses. The various branching paths may overlap, involve differing amounts of operational data and may contradict portions of the operational data. This set of paths is then used as the starting material for a process which ultimately may result in discovery of one or more plausible, empirically testable, data driven cause and effect insights, at the level of the biochemistry under investigation.

The process involves winnowing or “hypothesis pruning,” and is done by applying logic based, software-implemented criteria to the set of branching paths to reject paths as not likely representative of real biology. This serves to eliminate hypotheses and to identify from remaining hypotheses one or more new active causative relationships. The logic based criteria may be embodied as one or more algorithms, typically many used together, designed fundamentally to eliminate paths not likely to represent real biology. A number of such criteria are disclosed herein as non-limiting examples. Those skilled in the art can devise others.

After this pruning process, one, a few, or perhaps a dozen or so alternative or complementary hypothetical biochemical explanations of the data remain. These may be inspected by a scientist, rejected on the basis of her judgment and other factors not embodied in the software based winnowing algorithms, or accepted at least tentatively, and combined to produce a detailed model of the operational data under study. This “causal system model” in turn may be used to make simulation-based predictions, and these in turn can be validated or refuted by wet biology experimentation.

Preferred ways to make and use the various components of the method and system of the invention will now be explained in more detail.

### II.B. The Knowledge Base

As disclosed in detail in U.S. application Ser. No. 10/644,582 (Publication Number 2005-0038608) filed Aug. 20, 2003 entitled “System, Method and Apparatus for Assembling and Mining Life Science Data,” biological and other life sciences knowledge can be represented in a computer environment in a form which permits it to be computationally probed, manipulated, and reasoned upon. Such data structures can be reasoned upon by algorithms that are designed to derive new knowledge and make novel conclusions relevant to furthering the understanding of biological systems and its underlying mechanisms. Providing such a knowledge base permits harmonization of numerous types of life science information from numerous sources.

The knowledge base preferably is constructed using “frames” that represent standard “cases,” which permit biological entities and processes to be related in a well-defined patterns. An intuitive “case” is a chemical reaction, where the reaction defines a pattern of relations which connect reactants, products, and catalysts. The case frames provide a representational formalism for life sciences knowledge and data. Most case frames used in the system are derived from “fundamental” terms by functional specification and construction. This technique, essentially similar to skolem terms in formal logic, has been used in previous representation systems, such as the Cyc system (Guha, R. V., D. B. Lenat, K. Pittman, D. Pratt, and M. Shepherd. “Cyc: A Midterm Report.” Communications of the ACM 33, no. 8 (August 1990)).

Fundamental terms are either created as part of basic biological ontology or derived from public ontologies or taxonomies, such as Entrez Gene, the NCBI species taxonomy, or the Gene Ontology (Gene Ontology: tool for the unification of biology. The Gene Ontology Consortium (2000) Nature Genet. 25: 25-29.). These terms typically are assigned unique identifiers in the system and their relationship to the public sources preferably is carefully maintained. An example of a fundamental term is the protein class “TP53 Homo sapiens,”—the class of all proteins which meet the criteria of the TP53 Homo sapiens entry in the Entrez Gene database. Another example is the term “apoptosis,” the class of all apoptosis processes meeting the criteria of the Gene Ontology term. Generally, the entries in the system are referred to as “nodes,” and these can represent not only biological entities and functional biological activities, but also biological actions (generally one of “inhibit” or “promote”) and biological concepts (biological processes or states which themselves are characterized by underlying biochemical complexity).

Some examples of nodes include:
kinaseActivityOf(X)
input: the protein class or a complex class X, where X must be annotated with protein kinase activity
output: the class of all processes where X acts as a kinase
complexOf(X,Y)
input: two protein classes or complex classes X and Y
output: the class of all complexes having exactly X and Y as components
X̂Y
input: two classes of biological entities or processes
output: the class of all processes in which some members of class X increase the amount, abundance, occurrence, or frequency of members of class Y

The functional specification, construction, and retrieval of a case frames system allows the practical use of a very large number of highly specific case frames derived from the ontology of fundamental terms, such as specialized sets of proteins, activities of proteins, processes of increase and decrease, etc. Because a scientist adding knowledge to the knowledge base can simply refer to new case frames by their specification, the speed and accuracy of data accretion and knowledge modeling is accelerated. For example, to state “MAPK8 proteins, acting as kinases, can increase the transcriptional activity of JUN proteins” reduces to a simple functional expression that returns a case frame representing this process of increase:
kaof(MAPK8)̂taof(JUN)
   Most important, the use of these specialized case frames allows the modeling of complex biology with many case frames but a small number of relationship types. It enables the relationships in the system to have simple semantics despite the complexity of the biology. A subset of relationships in the system may be designated as “causal” so that causal reasoning algorithms can use them to propagate and infer causality. Many relationships have a defined “direction” indicating which of its end points is considered the “upstream” case frame and which the “downstream” case frame. The use of functionally generated case frames for the processes of increase and decrease also facilitate a simple and elegant implementation of a powerful feature: an increase or decrease can itself direct an increase or decrease. For example, to express “X suppresses the increase of Y by Z”, we simply state “X−|(ẐY)”, where the inner function specifies the increase of Y by Z and the outer function operates on X and the case frame for ẐY.

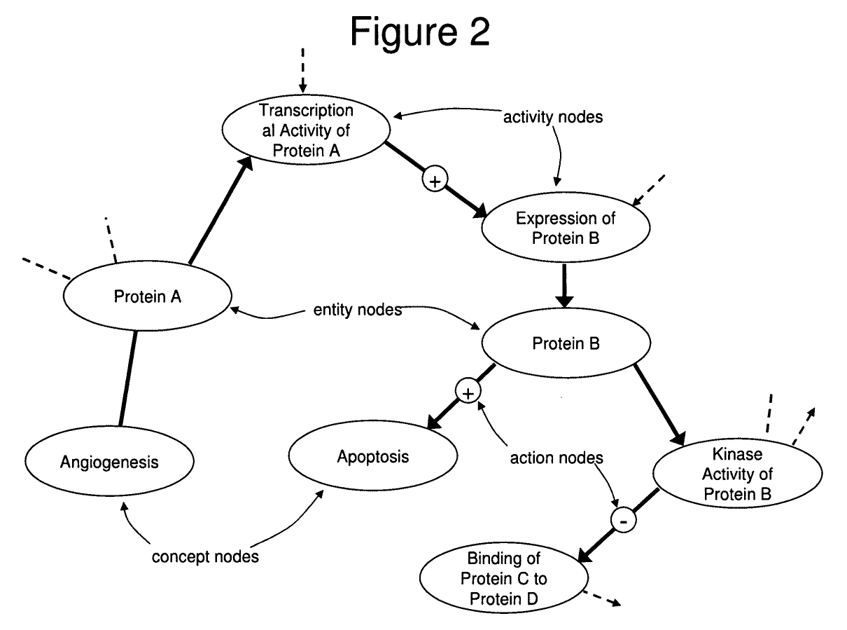

FIG. 2 is a graphic illustration of the elemental structure of the preferred knowledge base. Thus, plural nodes, typically generated and maintained as case frames, and here illustrated as spheroids, variously represent biological entities, such as Protein A and Protein B, biological concepts, such as apoptosis or angiogenesis, activities, such as the transcriptional activity of Protein A or expression of protein B, and actions, such as +, meaning up regulate or enhance, and −, meaning down regulate or inhibit. Each nodes is connected to at least one other node, and typically to many other nodes (illustrated as dashed lines), so as to model the various biological interrelationships among biological elements and to break down the complexity of any given biological system into elemental structures and interactions. The connections in this illustration represent that there is some relationship between the nodes linked to each other. For example, Protein A is correlated with angiogenesis, but the model is silent as to whether it is a cause of angiogenesis, a result of it, or neither. Arrows here reflect the indicia in the knowledge base of directionality of the relationship. For example, the level of Protein B is causal of the kinase activity of Protein B, but the reverse has no causal relationship; an increase in the level of Protein B also increases the biological process of apoptosis, but again, an increase in cells undergoing apoptosis in this biological system does not cause an increase in Protein B; and the kinase activity of protein B inhibits binding of Proteins C and D.

### II.C. Generation of Assemblies

A preferred practice in the production of CSMs for use in the practice of the present invention is to extract from a global knowledge base a subset of data that is necessary or helpful with respect to the specific biological topic under consideration, and to construct from the extracted data a more specialized sub-knowledge base designed specifically for the purpose at hand. In this respect, it is important that the structure of the global knowledge base be designed such that one can extract a sub-knowledge base that preserves relevant relationships between information in the sub-knowledge base. This assembly production process permits selection and rational organization of seemingly diverse data into a coherent model of the biochemistry and molecular biology of any selected biological system, as defined by any desired combination of criteria. Assemblies are microcosms of the global knowledge base, can be more detailed and comprehensive than the global knowledge base in the area they address, and can be mined more easily and with greater productivity and efficiency. Assemblies can be merged with one another, used to augment one another, or can be added back to the global knowledge base.

Construction of an assembly begins when an individual specifies, via input to an interface device, biological criteria designed to retrieve from the knowledge repository all assertions considered potentially relevant to the issue being addressed. Exemplary classes of criteria applied to the repository to create the raw assembly include, but are not limited to, attributions, specific networks (e.g., transcriptional control, metabolic), and biological contexts (e.g., species, tissue, developmental stage). Additional exemplary classes of criteria include, but are not limited to, assertions based on a relationship descriptor or on text regular expression matching, assertions calculated based on forward chaining algorithms, assertions calculated based on homology, and any combinations of these criteria. Key words or word roots are often used, but other criteria also are valuable. For example, one can select assertions based on various structure-related algorithms, such as by using forward or reverse chaining algorithms (e.g., extract all assertions linked three or fewer steps downstream from all serine kinases in mast cells). Various logic operations can be applied to any of the selection criteria, such as “or,” “and,” and “not,” in order to specify more complex selections. The diversity of sets of criteria that can be devised, and the depth of the assertions in the global knowledge base, contribute to the flexibility of use of the invention.

Assemblies created in this way usually are better than the global knowledge base or repository they were derived from in that they typically are more predictive and descriptive of real biology. This achievement rests on the application of logic during or after compilation of the raw data set so as to augment the initially retrieved data, and to improve and rationalize the resulting structure. For example, assemblies can be generated to be species or tissue specific, which limits the number of objects in subsequent computations and, thus, can make subsequent computations more manageable. This can be done automatically during construction of the assembly, for example, by programs embedded in computer software, or by using software tools selected and controlled by the individual conducting the exercise.

The production of an assembly thus involves a subsetting or segmentation process applied to a global repository, followed by data transformations or manipulations to improve, refine and/or augment the first generated assembly so as to perfect it and adapt it for analysis. This is accomplished by implementing a process such as applying logic to the resulting knowledge base to harmonize it with real biology. An assembly may be augmented by insertion of new nodes and relationship descriptors derived from the knowledge base and based on logical assumptions. For example, generating new assertions in the construction of an assembly for species Y can involve recognizing an assertion between proteins A and B in species X and identifying that A and B in species X are homologous to A′ and B′ in species Y. A new assertion between A′ and B′ can be hypothesized and added to the assembly for species Y even though that specific assertion is not found in the Knowledge Base. Conversely, an assembly may be filtered by excluding subsets of data based on other biological criteria. The granularity of the system may be increased or decreased as suits the analysis at hand (which is critical to the ability to make valid extrapolations between species or generalizations within a species as data sets differ in their granularity). An assembly may be made more compact and relevant by summarizing detailed knowledge into more conclusory assertions better suited for examination by data analysis algorithms, or better suited for use with generic analysis tools, such as cluster analysis tools. Assemblies may be used to model any biological system, no matter how defined, at any level of detail, limited only by the state of knowledge in the particular area of interest, access to data, and (for new data) the time it takes to curate and import it.

In one example of assembly production, new, application oriented knowledge may be added to a global repository in a stepped, application-focused process. First, general knowledge on the topic not already in the global repository (e.g., additional knowledge regarding cancer) is added to the global repository. Second, base knowledge is gathered in the field of inquiry for the intended application (e.g., prostate cancer) from the literature, including, but not limited to, text books, scientific papers, and review articles. Third, the particular focus of the project (e.g., androgen independence in prostate cancer) is used to select still more specific sources of information. This is followed by inspection of the experimental data under consideration using the data to guide the next step of curation and knowledge gathering. For example, experimental data may show which genes and proteins are involved in the area of focus.

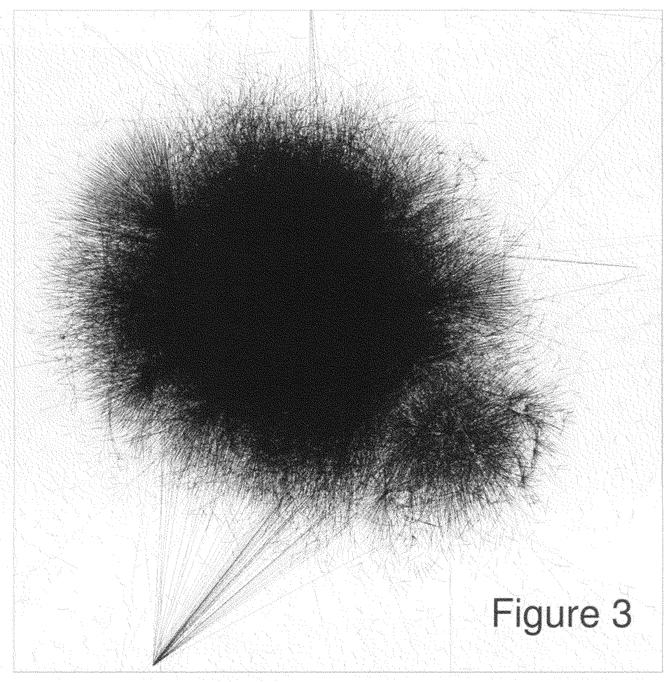

FIG. 3 is a graphical representation of an assembly embodying approximately 427,000 assertions, some 204,000 nodes, and their connections. A knowledge base from which this assembly was derived is much larger and much more complex. As shown, the assembly itself can be very large, and when graphically represented takes the form of an interconnected web representative of biological mechanisms far too complex to be understood, rationalized, or used as a learning tool without the aid of computational tools. It is a collection of specific nodes and their connections within the assembly that are used as raw materials to explain a particular data set and forms the basis of a causal analysis exercise.

### II.D. Generation of Hypotheses by Simulation

Next, path finding and simulation tools are used to probe the assembly with a view to defining a set of branching paths present in the assembly. Suitable tools are described in the aforementioned U.S. pending application Ser. No. 10/992,973, filed Nov. 19, 2004 (U.S. publication Serial No. 2005-0165594). Generally, the software implemented tools permit logical simulations: a class of operations conducted on a knowledge base or assembly wherein observed or hypothetical changes are applied to one or more nodes in the knowledge base and the implications of those changes are propagated through the network based on the causal relationships expressed as assertions in the knowledge base.

These methods are use to hypothesize biological relationships, i.e., branching paths through connected nodes in a knowledge base or assembly of the type described above, by reasoning about the downstream or upstream effects of a perturbation based on the biological knowledge represented in the system. A root node is selected in the knowledge base. Root nodes may be selected at random, or may be known, e.g., from experiment based operational data, to correspond to a biological element which increases in number or concentration, decreases in number or concentration, appears within, or disappears from a real biological system when it is perturbed. From this node software traces via simulation preferably forward, less preferably backward, or both, within the knowledge base from the root node through the relationship descriptors preferably downstream along a path defined by linked, potentially causative nodes to discern paths hypothetically consequence of (for downstream simulation) or responsible for (for upstream simulation) the experimentally observed or assumed perturbations in the root nodes. In one embodiment, downstream simulation is conducted from all nodes in the assembly. Many of these branching paths may involve no nodes corresponding to the operational data; others will involve a few or many nodes corresponding to the operational data.

The path finding may involve reverse causal or backward simulation, but forward simulation is preferred. Models of the chains of reasoning may be simplified by removing superfluous links. Thus, when a branching path is delineated, links or nodes which are dangling or represent dead ends in the tree, or lead to other nodes, none of which are involved in the operational data, may be removed. Typically, all nodes which have no downstream links and are not a target node are removed. This step may produce more dangling nodes, so it may be repeated until no dangling nodes are found. This action serves to identify the chains of causation in an assembly which are upstream or downstream from any selected root node and which are in some way consistent or involved with a particular set or sets of experimental measurements.

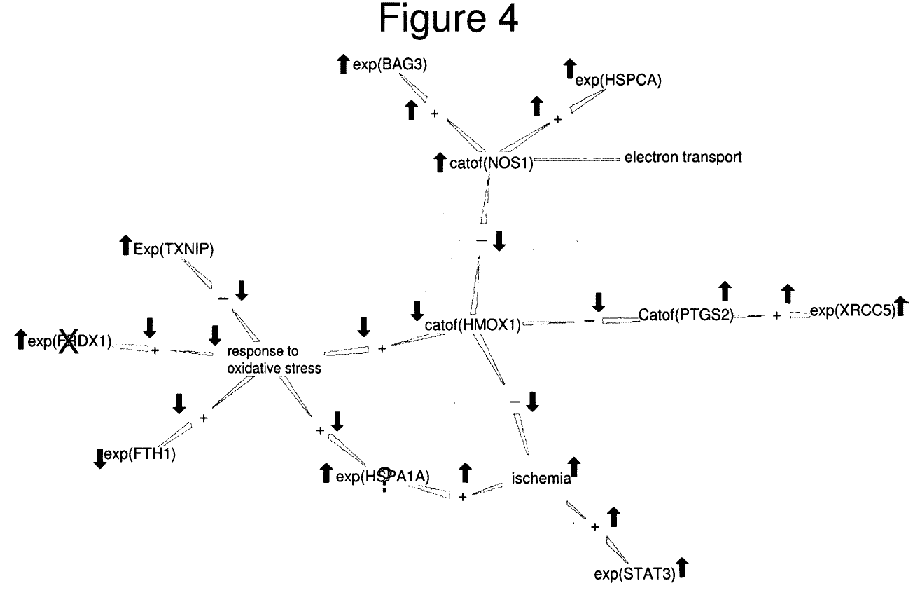

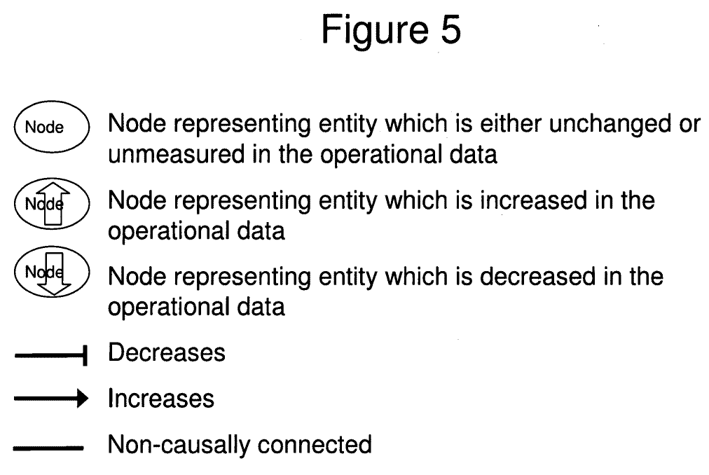

FIG. 4 is a simplified graphical representation of one exemplary branching path underlying a hypothesis. In this drawing, nodes are graphically represented as grey-tone vertices marked with an identification of a biological entity, action, such as increase (+) or decrease (−), functional activity, such as exp(TXNIP), or concept, such as “ischemia,” or “response to oxidative stress”. The node exp(TXNIP) represents the process of expression of the gene TXNIP. The root node of the hypothesis model is catof(HMOX1), representing increased catalytic activity of HMOX proteins.

Nodes which are related non-causally are connected by lines (see, e.g., catof(NOS1)-electron transport), causal connections by a triangle; the point of the triangle representing the downstream direction. For example, the model states that catof(NOS1) causes an increase (+) of exp(BAG3) and exp(HSPCA). The question mark indicates an ambiguity (the model indicates exp(HSPA1A) both increases and decreases). The exp( ) nodes correspond to operational nodes. The direction of the operational data is mapped onto the model here in the form of bolded up or down facing arrows by the exp( ) nodes. Bolded up or down facing arrows on non-operational data correspond to predictions based on the root hypothesis of increased catalytic activity of HMOX proteins, represented by the node catof(HMOX). While this model and operational data agree well, X marks a node where the model and the operational data contradict.

The operational data is the focus of the inquiry. It typically is generated from laboratory experiments, but may also be hypothetical data. The operational data set may, for example, be embodied as a spreadsheet or other compilation of increases and decreases in a set of biomolecules. For example, the data may be changes in concentrations or the appearance or disappearance of biomolecules in liver cells induced in an experimental animal such as mice or in vitro upon administration or exposure to a drug. The drug may have caused liver toxicity in one strain of mice and not in others. The question may be: what is the mechanism of the toxicity? As another example, the data may be obtained from tumor and normal tissues. In this case the question may be “what critical mechanisms are present in the tumor samples and not in the normal samples?” or “what are possible interventions that might inhibit tumor growth?” The data also may be from animals treated with different doses of a candidate drug compound ranging from non-toxic to toxic doses. It often is of interest to completely understand the mechanism of toxicity and to determine rational biomarkers diagnostic of early toxicity that emerge from this understanding. Such biomarkers may be developed as human biomarkers and used in monitoring clinical trials.

Either before or after the raw path finding step, operational data is mapped onto the nodes in the assembly, or onto the nodes in respective raw branching paths. Mapping is conducted by fitting the operational data within the network by identifying nodes that correspond to the operational data points and assigning a value (increase or decrease) correlated with the data for each node. The raw branching paths then are ranked, preferably first on the basis of the number of nodes in a candidate path that touch the operational data, and then with more sophisticated techniques. Stated differently, filtering criteria are applied to the set of branching paths based on assessments of how well a path predicts the operational data. Paths which are unlikely to represent real biology are removed from consideration as a viable hypothesis. By a process of winnowing or pruning, the methods identify one or more remaining paths comprising a theoretical basis of a new hypotheses potentially explanatory of the biological mechanism implied by the data.

By way of further explanation, in one case, a researcher may be interested in elucidating the mechanisms of some outcome in a biological system, and may conduct a series of experiments involving perturbations to the system to see which perturbations result in that outcome. An example may be a high-throughput screening experiment, such as a screen of drugs vs. one or more cell lines to see which ones produce phenotypes such as apoptosis, cell proliferation, differentiation, or cell migration. In the other case, researchers interested in a particular perturbation may take many measurements to observe effects of that perturbation. For example, the focus may be an effort in gene expression profiling involving an experiment in which a specific perturbation—drug target, over-expression, knockdown—is performed.

Mapping data from these experiments to a knowledge model, one obtains a model which, for a given depth of search, is the sum of all upstream causal hypotheses explaining the outcome. This is the “backward simulation” from the node representing the outcome. Alternatively, a model can be produced which, for a given depth of search, is the sum of all downstream causal hypotheses which predict the effects of the perturbation. This is the “forward simulation” from the node representing the quantity which is perturbed. Typically, for a given experiment and its resulting data, the first question is: “what happened in this experiment?” The answer provided by the methods disclosed herein is, first: “Here are the chains of reasoning which are present in the knowledge base and which potentially can explain the data,” and second, as explained more fully below: “here are the chains that are most consistent with the observations.” It is the latter models which comprise the product of the causal analysis methods disclosed herein.

### II.E. Hypothesis Pruning Techniques

A large number of hypotheses may be identified, each of which potentially explains at least some portion of the operational data. Accordingly, another step in creating a causal system model is to apply logic based criteria to each member of the set of models to reject paths or portions thereof as not likely representative of real biology. This “hypothesis pruning” leaves one or a small number of remaining models constituting one or more new active causative relationships. Accordingly, the invention provides a class of algorithms designed to prune branching paths or models of causal explanation based on real experimental or hypothetical measurements comprising the operational data.

As nonlimiting examples, the logic based criteria may be based on
A measure of consistency between the predictions resulting from simulation along a model and known biology (e.g., not involving the operational data) of the selected biological system.
Using as a filter a group of models generated by mapping against random or control data to eliminate models from the set of models.
An assessment of descriptor nodes associated with each model for consistency with known aspects of the biology of the selected biological system. For example, the assessment may be based on mutual anatomic accessibility of the nodes representing entities in a given branching path, and answers the question: are all biological elements in the path known to be accessible in vivo to its connected neighbors?
A measure of consistency between the operational data and the predictions resulting from simulation along a branching path, and may seek to answer questions such as: does the perturbation of the root node correspond to the operational data, e.g., the observed wet biology data under examination? Does this path which contains, e.g., 7 nodes corresponding to operational data points, predict their increase or decrease consistently with the operational data? What is the number of nodes perturbed in a linear path comprising a portion of a branching path which correspond to the operational data?
A determination of a pair, triad or higher number of branching paths which together best correlate with the operational data. Optimal combinations may be determined by applying combinatorial space search algorithms, such as a genetic algorithm, simulated annealing, evolutionary algorithms, and the like, to the multiple branching paths using as a fitness function the number of correctly simulated data points in the candidate path combinations.
Whether a branching path comprises linear paths wherein plural nodes are perturbed in the same direction as the operational data, or comprising multiple connections to concept nodes, e.g., to nodes representing complex biological conditions or processes under study such as apoptosis, metastasis, hypoglycemia, inflammation, etc.

Pruning is done for the purpose of producing a reduced model and/or a reduced number of models representing only the causal hypotheses which are fully or partially consistent with the data and preferably with themselves. Obtaining these answers is therefore a matter of pruning the models or reducing their number by eliminating chains of reasoning inconsistent with the data and to produce a succinct, parsimonious answer or set of answers representing new hypotheses. Thus, paths which are superfluous may be pruned from within a branching path or model. This is typically a case where a short path may be eliminated in favor of a longer path that expresses greater causal detail. The criteria for “consistency with the observations” and “superfluous paths” are not absolute. The researcher can devise different definitions for these concepts and the pruned models which express the “answers” will be different.

For example, the many raw hypotheses generated by the method as set forth above preferably are reduced first by assessment of each for “richness” and “concordance.” These concepts are explained with reference to FIG. 6 and FIG. 7. As illustrated in FIG. 6, the root node is causally connected to nodes 2, 3, and 4. Node 3 has no counterpart in the operational data. Nodes 2 and 4 each are causally linked to two nodes. Of the seven nodes linked to the root node, operational data is mapped onto six. This is a “rich” hypothesis and would have a high priority. Models are favored when more than one of the plural other nodes turn out to be nodes represented by data points in the operational data. Preferably, the algorithm assesses whether the fraction of the plural other nodes linked directly to a node which map to the data is greater than the data base average fraction of plural other nodes which map to the data.

However, note that according to the model of FIG. 6, increase of node 4 should induce an increase in node 7, but the operational data shows that the entity node 7 represents in fact is decreased. This leads to the concept of concordance, (see FIG. 7) which refers to resolution of the question, with respect to each model, “what fraction of nodes correspond to the operational data,” i.e., what fraction of predicted increases or decreases corresponds to increases or decreases in the operational data. Models with high concordance are preferred over models with lower concordance. There is a trade-off between richness and concordance (only one of many such trade-offs encountered in the pruning of raw hypotheses) which is addressed by setting criteria which may be rather subjective and depend on the desired output of the system.

After application of richness and concordance algorithms, in a typical exercise, the number of surviving models may range from tens to thousands, depending on the criteria applied, the granularity of the assembly, the biological focus of the model, etc. Next, one or more, typically many, logic based algorithms are applied to remaining hypotheses to further prune the models and to approach a mechanism reflective of real biology. Several currently preferred pruning and prioritization techniques are discussed below. Others can be devised by persons of skill in the art.

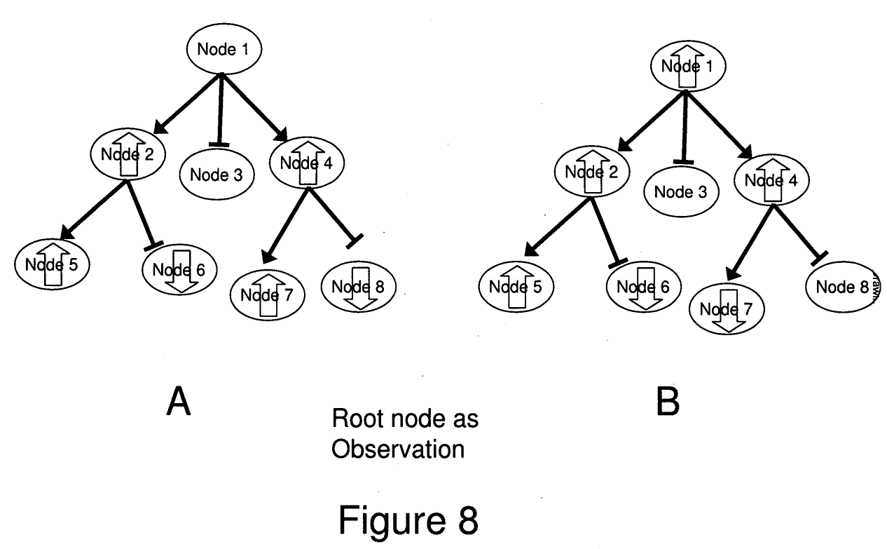

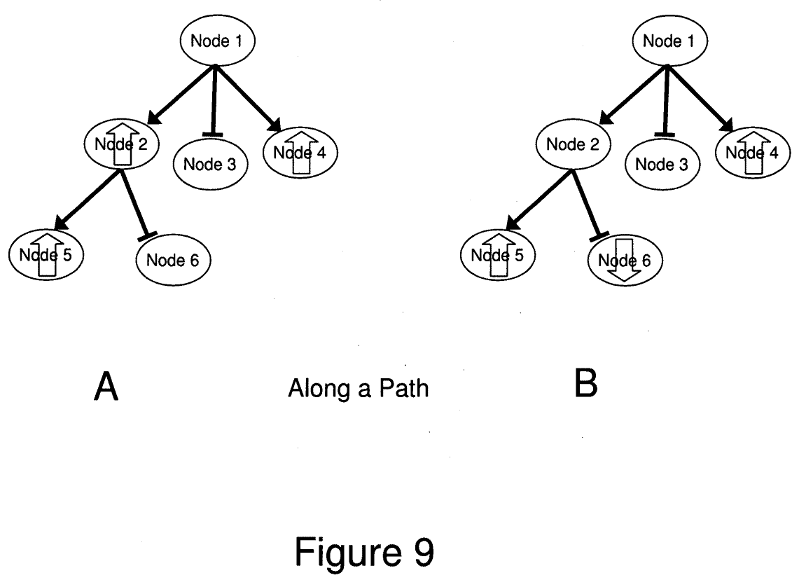

Perhaps the simplest logic based criteria, after richness and concordance, is to search for models where the root node represents an entity that appears and is in accordance with the operational data. For example, as shown in FIG. 8, models A and B have the same root, define the same pathways, and have the same richness and concordance. However, model B is preferred as the root node corresponds (is in concordance with) the operational data. Another example appears in FIG. 9. Here, again, models A and B have the same root, define the same pathways, and have the same richness and concordance. In this case model A is preferred as plural nodes mapping to the data appear in a chain, and therefore model A has a higher probability of representing real biology than model B.

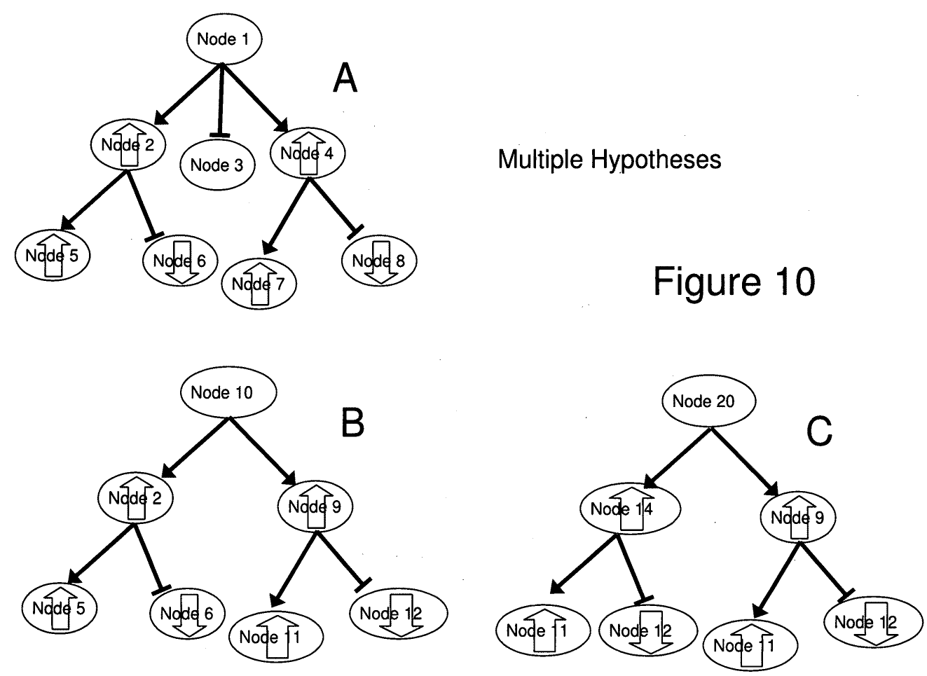

Another criterion is illustrated in FIG. 10. If model A is a previously selected hypotheses, Model C is preferred over Model B because there is less overlap between the observational data explained by model A and model C. Model C therefore is more likely to be informative and helpful in discovering new real biology in this exercise.

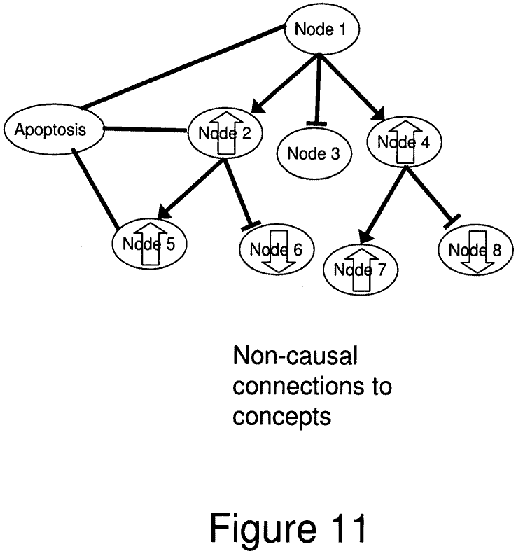

FIG. 11 illustrates one of a series of pruning criteria bases on the extent to which a given model is in accordance with known biology. This type of algorithm need not necessarily involve operational data mapping. When, as preferred, the assembly includes non causal data, these often can be used to eliminate models as not possibly representative of real biology, or to raise a score of the model because it fits well with known biology.

As illustrated in the model of FIG. 11, three nodes, two of which map to and are concordant with the operational data, are each connected to the concept node “apoptosis.” If the biology under study involves apoptosis, this model is favored over others which comprise fewer such links. Models comprising multiple non causal links that correctly map to entries in knowledge bases of proteins or genes, such as GO categories, etc. are preferred. Generally, models exhibiting multiple causal connections to a concept node or to a phenotype involved in the biology under study also are preferred.

Another particularly powerful known biology-based algorithm exploits “locality,” the location implied by interactions, addressing the question: “are the entities represented by the nodes in a model known to be in anatomical proximity?” Thus, in curating the knowledge base or assembly, explicit translocation events can specify that transportation of particular entities between locations is possible. Things which bind, touch, participate in reactions, transcription factor activity, are all “direct”, their participants must be in the same locality or location even if the exact location is unknown. If a direct interaction process has no designated location, or if it is only known to occur in a general location, it nonetheless may only occur if its participants are available in the same locality. If interactions which are direct—either explicitly or by class (all reactions) are identified, it is possible to attempt to find hypotheses in which each step satisfies the constraints of locality.

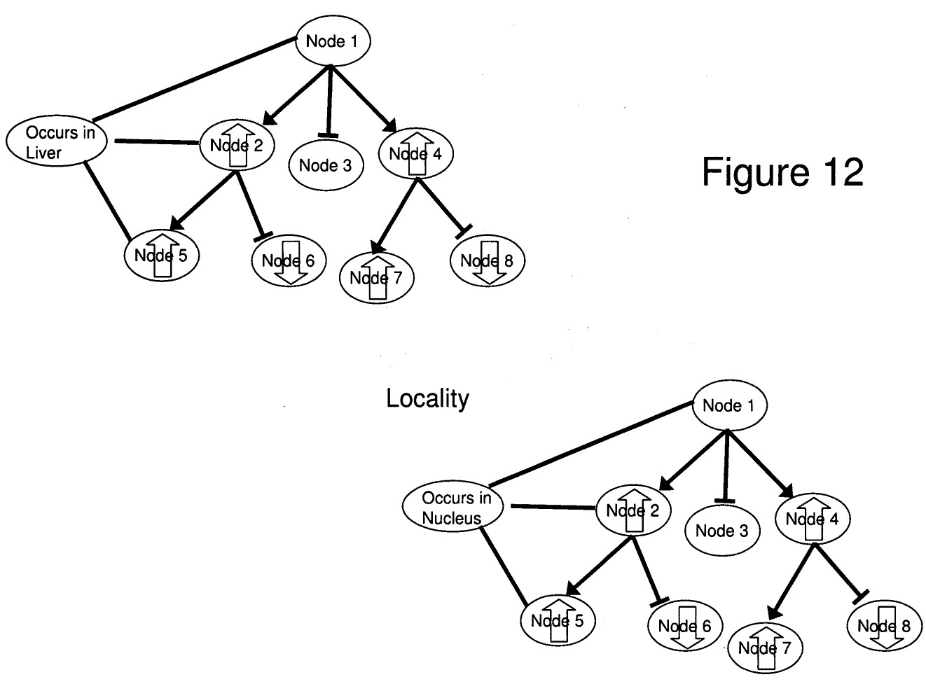

Thus, the locality filter removes or downgrades the priority of models where the entities are known (by virtue of non causal connections in the assembly) to reside in different organelles, different cell types, different tissues, or even different species, etc. Conversely, as illustrated in FIG. 12, models comprising multiple nodes representing functions or structures known to be present in an anatomical or micro-anatomical locality under study, and therefore mutually anatomically accessible, are preferred.

This figure and example also include mapped operational data and illustrate that they are consistent with the model, but this is an optional feature.

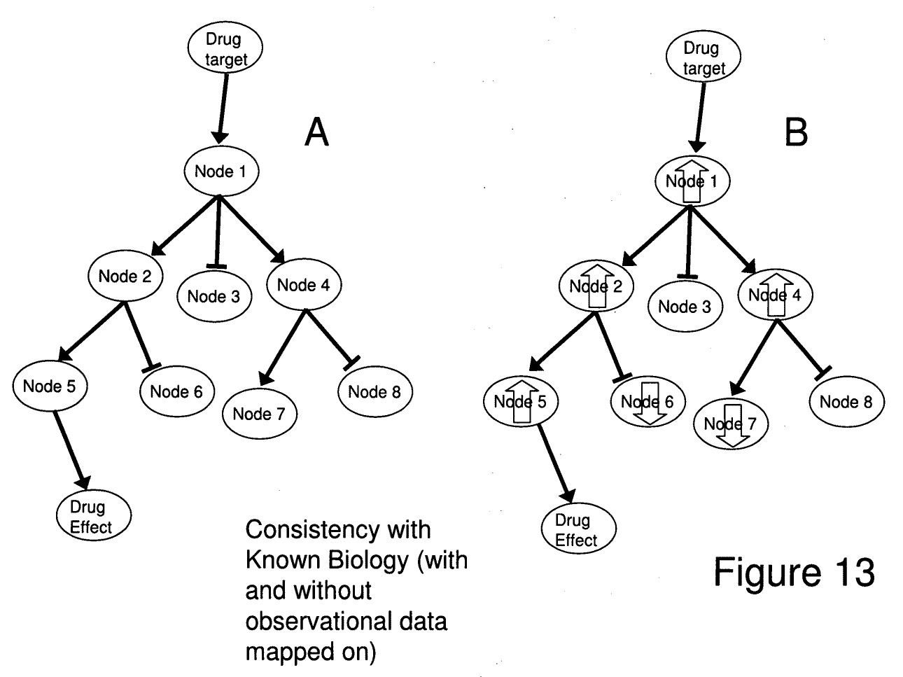

The latter point may be understood better with reference to FIG. 13. Here, two copies of the same model are shown illustrating a path from a drug target node to a drug effect concept node. In model A, none of the operational data map to the nodes, but this might still be a plausible mechanism, if, for example, no measurements were made of the activities represented by these nodes in generation of the operational data set. In model B, the path is revealed to be rich (six nodes involve operational data) and high in concordance (five of the six nodes correctly predict the direction of the data).

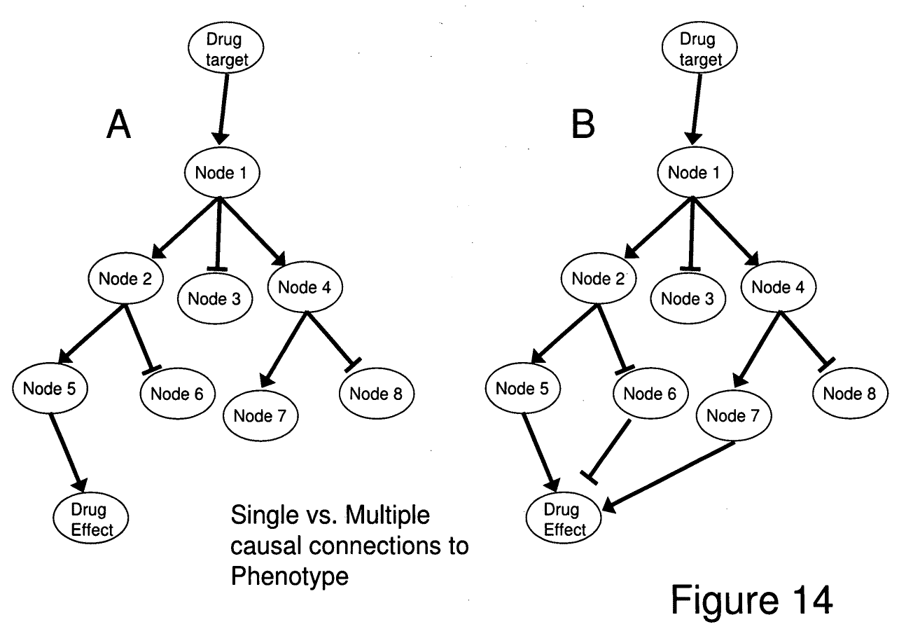

Yet another real biology-based criterion is illustrated in FIG. 14. Here, model B is favored over A because multiple nodes connect to the phenotype under study. Again, it is more likely that B represents real biology and will be informative of the mechanism of the biology under study.

Another type of algorithm applied to prune raw or rich hypotheses involves mapping the models against random or control data, and then using the models as a filter. In this approach, some basic statistical scores are developed for a number of hypotheses derived from a set of state changes. These same statistical scores are calculated for these hypotheses scored using random datasets generated to have similar network connectedness as the original dataset. Statistical scores based on the original data must be more significant than scores based on randomized data in order for the hypothesis to be considered further.

It is also possible to determine whether a plurality of models together best correlate with the operational data This may be done by applying a genetic or other algorithm designed to search combinatorial space to multiple models with nodes in common, with the number of correct node simulations as a fitness function.

This pruning exercise results in a smaller number of models, small enough to be examined in detail by a trained biologist, who will apply his knowledge to decide which of the hypotheses are likely to be viable explanations of the operational data. It is often possible to combine hypotheses into a more complex unified hypotheses. Even at this stage, because of the complexity of systems biology, there may be mutually exclusive hypotheses. Some may be eliminated from further consideration on various rational grounds not embodied in the assembly. Others may suggest additional experiments which can validate or refute the hypothesis.

Thus it can be appreciated that these methods and systems provide an engine of discovery of new biological causes and effects, facts, and principles, and provide a valuable analysis tool useful in advancing knowledge of the mechanisms of biological development, disease, environmental effects, drug effects, toxicities and the biological basis of diverse phenotypes, all on a detailed biochemical and molecular biology level.

### III. Comparing Causal System Models

The methods of the present invention comprise comparing two or more CSMs representative of biological states. The comparison may be used to assess biological similarities and/or differences between the biological states. In addition, the comparison may be used to generate a “general” CSM to describe a general biological phenomenon in a model. Such comparisons may enable identification of common biological networks (presented as a general CSM) representative of a general drug efficacy, toxicity or biological state. Comparisons also may reveal biological entities or systems of biological entities for drug modulation of selected biological systems. Comparisons also may be designed to inform selection of an animal model or target biological network for drug testing that will be more informative of the drug's effects and/or toxicity in humans. Comparisons (e.g., comparison of a general CSM with an individual CSM) may be designed to identify unique perturbations in the individual biological system associated with the individual CSM.

The therapeutic advantages and/or disadvantages of systemic biological changes observed as a result of a perturbation to a biological system can be unclear using conventional approaches. Accordingly, the comparison of one or more causal system models (“CSMs”) as described by the present invention may be used to identify key biomolecular networks and unique biological phenomena that may associate with therapeutic advantages and/or disadvantages.

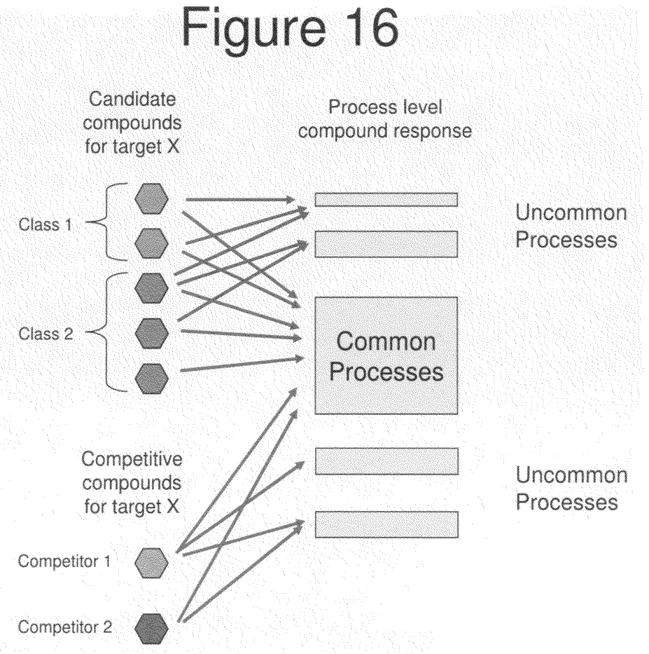

Identification of such key biomolecular networks can be used, for example, to identify biological phenomena (i.e., biomolecules or biological mechanisms or processes) specific to one biological state (e.g., elicited by administration of one compound) within a group of similar biological states (e.g., elicited by administration of similar compounds) to identify, improve or validate drug efficacy; to identify general drug efficacy or drug toxicity; to direct a search for more efficacious and/or less toxic drugs; and/or to identify biomolecular mechanisms generally associated with efficacy or toxicity of a class of drugs, or associated with any biological phenomena, such as a disease type. FIG. 16 graphically illustrates how different compounds, different classes of compounds, and/or competitive compounds can elicit common and different biological processes in a biological system.

### III.A. Overview

As shown in the top part of FIG. 16, all five compounds in both class 1 and class 2 elicit “common processes,” but only select compounds elicit each of the “uncommon processes.” A similar comparison is shown between competing compounds in the bottom part of FIG. 16. In many scenarios, the common processes elicited by one or more compounds may be associated with the common efficacy of the compounds, while the uncommon processes may be associated with undesired side effects. However, depending on the compounds tested, various other scenarios also are possible. For example, an uncommon process can be associated with unique efficacy or a unique side effect while a common process may represent a common side effect among the compounds tested.

A CSM is a model of the biomolecular basis of a given biological state of an organism and, for example, records differences in the biochemistry of a tissue or organ in the biological state vs. a control state, such as homeostasis. A “general” CSM is a model of the biological entities, functional activities, concepts and/or actions that differ and/or are shared by two or more biological states (e.g., a general CSM generated by comparing two or more biological states). Accordingly, any CSM can represent a network of relationships and/or connections between biomolecules present in a biological state that may differ in amount, presence, or concentration from the same or similar biomolecules in a different biological state, for example, a healthy state vs. disease state, a disease vs. drug-treated state, or many different states elicited by administration of various molecular entities. For example, CSMs of the biological effects of each of the compounds shown in FIG. 16 can be generated according to methods described above, and compared to reveal common processes, e.g., associated with efficacy and processes unique to administration of a compound that may be associated with a side effect of that compound, for example, toxicity. Comparisons of these CSMs can elucidate biochemical/molecular biology sub-networks common to different drugs, to predict efficacy or toxicity, and to determine which compounds offer therapeutic advantages or disadvantages.

Accordingly, one aspect of the present invention provides a software assisted method for probing the pharmacology of a molecular entity in an animal. Specifically, a storage medium provides a plurality of CSMs. Each CSM comprises a collection of nodes representative of differences in plural biological entities, actions, functional activities, or concepts, and links between the nodes, at least some of which are indicative of there being a causal directionality between the nodes. Each model represents differences in the biochemistry (e.g., changes in the presence or concentration of a protein, nucleic acid, enzyme, or any biomolecule) of an animal or a part thereof which are induced by administering to the animal a selected molecular entity, a selected dose of a selected molecular entity, or a selected group of molecular entities. At least two of the CSMs are compared to discern biochemical similarities and/or differences between the biochemical effects of the different molecular entities, different doses of molecular entity, or different groups of molecular entities. Such comparative analyses permit the scientist to suggest and/or perform one or more biology lab experiments designed to support or refute the hypotheses derived from the exercise, to prioritize candidate compounds, to suggest specific compounds for further development, and/or to suggest a new use for a known molecular entity.

It should be appreciated that the CSM comparisons of the present invention are not limited to comparing biological effects of two or more administered compounds or molecular entities. For example, depending on the CSMs compared, the methods permit one to examine various biological phenomena at a systems level, for example, similarities and/or differences between two or more phenotypic traits, e.g., diseases and/or toxicities; between a general disease state or a toxic state and the biological effects of a molecular entity; between an efficacious molecular entity and a toxic molecular entity; and/or between a molecular entity administered efficaciously and the molecular entity administered in such a way as to produce toxicity. Moreover, a CSM modeling changes in biological networks in a minimally characterized system (administration of a novel compound) can be compared with the CSMs of more fully characterized systems (e.g., libraries of large numbers of CSMs, each modeling biological network changes elicited by administration of one or more compounds), or with one or more general CSMs modeling common changes elicited by administration of classes of compounds, in order to gain insights for the implications of the active networks seen in the minimally characterized system.

Comparisons among the CSMs may be forward or reverse. Thus, the comparisons can be done after an observation as an aid in explaining what is happening, or done in advance of any experimentation so as to enable predictions. Also, comparisons may be between two CSMs, e.g., between a model of the alteration in a biochemical system induced by drug X and a model of the alteration induced by drug Y, or between multiple CSMs, e.g., compare models from administration of 10 statins to identify mechanistic differences or toxicities unique to some subset of them. The CSMs may be generated from data known to the scientific community or from private data, and from data sets obtained from multiple animals (or multiple humans) so as to avoid making false inferences based on idiosyncratic biochemistries of individuals. It is understood, however, that data from a single individual can be used in a CSM, for example, if the biological systems of that one individual are under investigation.

By way of example, a CSM can model a diseased biological state; a toxic biological state; a similar biological state in a different species; a similar biological state from a different group within a species, for example, a genetically or geographically different group within a species; a biological state elicited by one or more environmental conditions; a biological state elicited by a medical treatment; a biological state elicited by one or more biological entities, for example, a toxic or a therapeutic drug; a biological state present at a stage of disease (e.g., initiation, progression, or regression); a biological state of an individual's sensitivity to a compound (e.g., molecular entity); a biological state of an individual's resistance to a drug or therapy, and/or any homeostatic biological state that is perturbed, for example, by any agent that causes biochemical change from an initial biological state. Any of those CSMs can then be compared.

The comparison of CSMs is computer-based and includes applying a collection of logic based criteria to discern similarities and/or differences between nodes or groups of nodes in the CSMs being compared. For example, comparison of CSMs can be based on how much overlap (i.e., identity) there is between the CSM nodes. The overlap can be compared to the overlap that would be expected by chance. In addition or alternatively, the comparison can include a threshold for “nearness” (i.e., one model has a protein activity, catalytic activity of protein A and one model has a related, but not identical node, expression of Protein A). The comparison can include an assessment of the concentration of overlap (i.e., if a specific section of the CSMs share overlap or if the overlap is diffuse throughout the CSMs. Moreover, in the comparison different weights and priorities (overlap or nearness) can be assigned to different nodes and/or classes of nodes. By way of example, more detailed discussion of preparing and comparing CSMs related to toxicity follows.

### III.B. Causal System Models of Toxicity

In certain embodiments, the methods of the invention relate to comparing two or more CSMs that yield information about a particular class of toxicity in a biological system. In some embodiments, each compared CSM may be indicative of toxicity, for example, induced by disparate insults. A general toxicity CSM can be generated from this comparison showing the biochemical network involved with the toxicity, or its etiology or its consequences. Plural CSMs from different time points in the development or resolution of a toxicity can be generated. In some embodiments, one compares CSMs induced by a toxic molecular entity or a less toxic molecular entity administered to the biological system. In some embodiments, one or more CSMs may be partially representative of toxicity, for example, in a comparison that includes molecular entities that elicit both toxic and therapeutic effects. In some embodiments, none of the CSMs may indicate toxicity, for example, in a comparison that includes molecular entities that each elicit a therapeutic effect and no apparent toxicity at the efficacious dose.

By way of example, in certain embodiments of the invention, three categories of CSMs, which are descriptive of three different categories of biological states can be compared to gain understanding about pharmacology in a biological system. The first category includes general toxicity CSMs (“Tox_{GEN}”). In this category, CSMs are developed to indicate the biochemistry of general toxicities relating to any given biological system, for example, a toxicity relating to the function of the heart, liver, kidney, nervous system, circulatory system, respiratory system, or immune system. Toxicities can be associated with ailments such as heart arrhythmias (e.g., Q-T elongation), liver cell toxicity, kidney toxicity, multiple sclerosis, asthma, cancer, autoimmune disorders, and/or chronic conditions such as diabetes, congestive heart failure spiral, emphysema, ischemic injury, hyperactive stomach acid, and vascular inflammation. Alternatively or in combination, the modeled toxicities may be associated with exposure to toxic conditions or agents, for example, exposure to asbestos, smoking, classes of molecular entities, as well as other general toxicities. Comparisons of CSMs for such toxicities can be used to model toxicity as a general type of toxicity (and can yield a general CSM for toxicity) that is induced by a number of different agents or interventions. Moreover, the information used to construct a general CSM of toxicity may be generated from data including publicly available data descriptive of the biochemistry of a particular toxicity or class of toxicities.

A second general category of CSMs that can be compared to gain understanding about toxicity in a biological system includes molecular entity-specific toxicity models (“Tox_{ME}”). This category includes CSMs that are descriptive of the toxic response to administration of a particular molecular entity (“ME”) or novel molecular entity.

Another category of CSMs includes efficaciously drugged models (“Eff_{ME}”). This category includes CSMs that are descriptive of the biochemistry of a biological system that has been successfully drugged (treated with a molecular entity) so that it moves toward a healthy state. It should be understood that any one model may comprise elements of more than one category. For example, Tox_{GEN} models can be developed by administering particular toxins to mammals, by sampling tissue from persons in a toxic state after exposure to a particular ME, or by comparing CSMs of the biochemical effects of a plurality of different molecular entities directed to the same target. As described in the Examples below, the toxicology of a molecular entity can be probed by comparing CSMs of the biochemical effects of a plurality of different molecular entities directed to the same target. Common toxic effects observed by comparison of such CSMs then can be used to generate a Tox_{GEN} CSM. Similarly, common efficacious effects observed by comparison of CSMs can then be used to generate a general CSM representative of an efficacious mechanism of action.

Also, it is understood that all drugs induce toxic effects (i.e. side effects) at some dose, and accordingly Eff_{ME} CSMs may include data informative of the toxicities of a primarily efficacious drug. Thus, a CSM of a biological state induced by any active ME can actually be a blend of Tox_{ME} and Eff_{ME}. Accordingly, the three categorizations described above are understood to serve to explain and clarify the methods of the present invention.

As shown in Table 1, many different types of comparisons can be performed between different categories of CSMs. For example, a Tox_{GEN} CSM may be compared with another Tox_{GEN} CSM (A vs. A), a Tox_{GEN} CSM may be compared with a Tox_{ME} CSM (A vs. B), a Tox_{GEN} CSM may be compared with an Eff_{ME} CSM (A vs. C), a Tox_{ME} CSM may be compared with another Tox_{ME} CSM (B vs. B), a Tox_{ME} CSM may be compared with an Eff_{ME} CSM (B vs. C), and/or an Eff_{ME} CSM may be compared with another Eff_{ME} CSM (C vs. C). Accordingly, there are at least six different possible types of comparisons between these three categories of CSMs. It is understood that this table of types of CSMs and comparisons is meant for exemplary purposes and is not meant to be an exhaustive list. Similar tables can be created for any biological phenomena.

TABLE 1
Exemplary CSM Comparisons Concerning Toxic Effects of Molecular
Entities.

| | A Tox_{GEN} | B Tox_{ME} | C Eff_{ME} |
|---|---|---|---|
| A Tox_{GEN} | understand the | understand | investigate what |
| | biochemical | toxicity of a | toxicities a ME may |
| | details of classical | ME for risk | have that may appear |
| | toxicities, e.g., | assessment | as rare adverse |
| | Q-T elongation | | events, at higher |
| | | | dosages, or with |
| | | | chronic |
| | | | administration |
| B Tox_{ME} | understand | determine which | understand the |
| | toxicity of a ME | of a plurality of | biochemistry of the |
| | for risk | drug candidate | differences between a |
| | assessment | MEs is least risky | toxic ME and an |
| | | from a toxicology | efficacious ME |
| | | standpoint | |
| C Eff_{ME} | investigate what | understand the | understand |
| | toxicities a ME | biochemistry of | mechanism of action |
| | may have that | the differences | of different MEs that |
| | may appear as | between a toxic | induce the same |
| | rare adverse | ME and an | phenotype or that |
| | events, at higher | efficacious ME. | address the same |
| | dosages, or with | | target. Find new uses |
| | chronic | | for known drugs. |
| | administration. | | |

Table 1 includes exemplary information that can be obtained from each of these comparisons. For example, using the Table coordinates of A, B, and C, the AA comparison facilitates understanding of the biochemical details of classical toxicities (e.g., Q-T elongation). The BB comparison facilitates determination of which of a plurality of drug candidate MEs is least risky from a toxicology standpoint. The CC comparison facilitates understanding of the mechanism of action (e.g., specific biochemical interaction through which a drug produces its pharmacological effect). As an example of a CC comparison, the efficacy of a molecular entity to induce a desired biological effect can be probed by comparing a CSM of the biochemical effects of that entity to a CSM of the biochemical effects of one or more different molecular entities which induce the desired biological effect. This comparison also may allow for the discovery of new uses for known drugs. The AB comparison facilitates understanding of the toxicity of a ME for risk assessment. For example, the toxicology of a molecular entity can be probed by comparing a CSM of the effects of administration to a mammal of that molecular entity to plural CSMs of generalized toxic responses.

The AC comparison facilitates investigation into what toxicities a ME may have that may appear as rare adverse events, at higher dosages, or with chronic administration. The BC comparison facilitates understanding of the biochemistry of the differences between a toxic ME and an efficacious ME, or the toxic and efficacious administration of a ME. These comparisons also can be used to determine whether or not a toxicity is inexorably associated with a desired modulation (“on-target”) of a particular target molecule or unrelated (or not inexorably associated) with a desired modulation (“off-target”) of a particular target molecule. In addition, the on-target and/or off-target toxic effects associated with agonizing or antagonizing a preselected target with a molecular entity can be probed by comparing a CSM of the biological effect of agonizing or antagonizing with a particular compound with a general CSM representing a mechanism of action for a similar group of compounds (see Example 1).

### IV. Computer-Based Generation and Comparison of CSMs

The methods for generating and comparing CSMs may be practiced by any entity which sets up a knowledge base and writes the software needed to implement the analyses as disclosed herein. The knowledge base, or an assembly extracted and based on a portion of it, may reside in memory on a computer any where in the world, and the various data manipulations leading to a causal analysis as disclosed herein implemented in the same or a different location, on the same or a different computer, or dispersed over a network. In one aspect, the process permits discovery by an investigator of mechanisms in the biology of a selected biological system, and comprises causing a second party entity or entities, e.g., an outside contractor or a separate group maintained within a pharmaceutical company to do one or a combination of the steps of providing the CSMs, comparing them, or taking action based on what they reveal. The second party entity may then deliver a report to the investigator based on the analysis proposing a hypothesis or multiple hypotheses explanatory of the biochemistry or pharmacology under investigation. The investigator typically will supply at least some of the operational data on which the analysis is based to a second party entity. The investigator may be situated in the country where this patent is in force and the second party entity may be outside the country where this patent is in force.

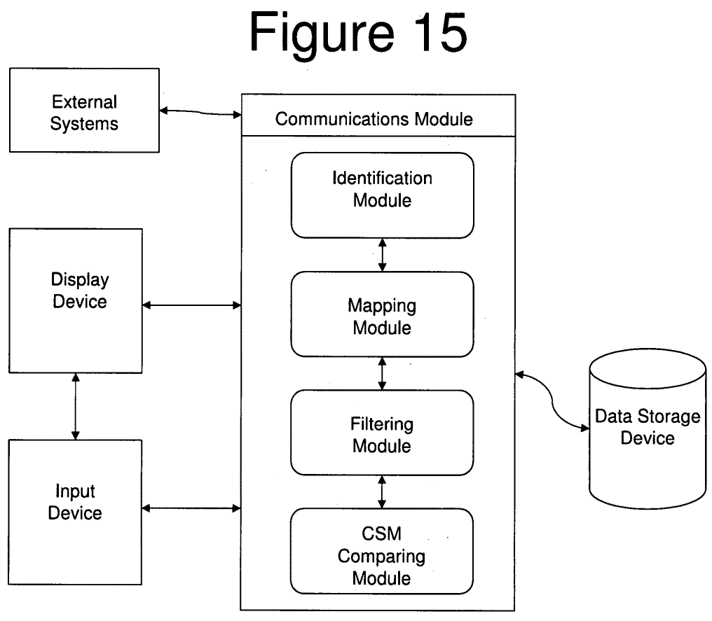

FIG. 15 schematically represents a hardware embodiment comprising a model building/hypothesis generating apparatus of the invention. As shown, it is realized as an apparatus to discover causative relationship mechanisms within a biological system, to generate CSMs, and to compare CSMs using the techniques described herein. The apparatus comprises a communications module, an identification module, a mapping module, filtering module and a CSM comparing module. In some embodiments, the invention also includes a knowledge base module for storing the data described above in one or more database servers, examples of which include the MySQL Database Server by MySQL AB of Uppsala, Sweden, the PostgreSQL Database Server by the PostgreSQL Global Development Group of Berkeley, Calif., or the ORACLE Database Server offered by ORACLE Corp. of Redwood Shores, Calif.

The communication module sends and receives information (e.g., operational data as described above), instructions queries, and the like from external systems. In some embodiments, a communications network connects the apparatus with external systems. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network can carry TCP/IP protocol communications, and HTTP/HTTPS requests made apparatus. The type of network is not a limitation, however, and any suitable network may be used. Non-limiting examples of networks that can serve as or be part of the communications network include a wireless or wired ethernet-based intranet, a local or wide-area network (LAN or WAN), and/or the global communications network known as the Internet, which may accommodate many different communications media and protocols. Examples of exemplary communication modules include the APACHE HTTP SERVER by the Apache Software Foundation and the EXCHANGE SERVER by MICROSOFT.

The identification module identifies one or more models within the biological knowledge base (shown, for example, in FIG. 1) that are potentially relevant to the functional operation of the biological system of interest using the techniques described above. The mapping module combines the received operational data and the models identified by the identification module, which can then be filtered by the filtering module based on assessments of whether a particular model predicts the operational data. The filtering module can remove models from consideration as a viable hypotheses, and thereby permits the identification of remaining models that can be used to provide potentially explanatory hypotheses relating to the biological mechanism implied by the data.

The CSM comparing module stores and compares any number of CSMs. Comparison of CSMs can yield further general CSMs, which can also be stored in the CSM comparing module. Such general CSMs can show unions or intersections of other CSMs. Software associated with the CSM comparing module also can identify and assign values of significance to nodes and/or connectors shared by all CSMs composed and/or that are unique to one or more CSMs compared. These significance values can be based on a number of logic based criteria. If a collection of CSMs have a number of nodes in common or that exceed predetermined thresholds according to the logic based criteria, these nodes can be deemed to be related to the networks involved in the commonalities of the states modeled. For example, if the modeled states are the administration of similar drugs, these commonalities may be related to their common phenotypic effects. Highly connected nodes that are not in common across all modeled CSMs may be deemed to be related to networks that are not activated in all of the modeled CSMs. For example, if the modeled states represent biological networks activated by administration of similar drugs, a non-common network activated in a CSM modeling a single drug may indicate a side effect or a unique biological pathway for therapeutic efficacy.

Upon identification of one or more CSMs and/or CSM comparisons, the related data (e.g., data tables, graphical images, collections of nodes and/or relationships) that constitute the one or more CSMs and/or CSM comparisons may be stored onto a computer-readable medium (e.g., optical or magnetic disk). These disks may then be provided to other entities for further analysis and testing.

The apparatus can also optionally include a display device and one or more input devices. Results of the mapping and filtering processes can be viewed graphically using a display device such as a computer display screen or hand-held device, but only very small portions of the model typically are comprehensible to a human through visual inspection. Where manual input and manipulation is needed, the apparatus receives instructions from a user via one or more input devices such as a keyboard, a mouse, or other pointing device.

Each of the components described above can be implemented using one or more data processing devices, which implement the functionality of the present invention as software on a general purpose computer. In addition, such a program may set aside portions of a computer's random access memory to provide control logic that affects one or more of the functions described above. In such an embodiment, the program may be written in any one of a number of high-level languages, such as FORTRAN, PASCAL, C, C++, C#, Tcl, java, or BASIC. Further, the program can be written in a script, macro, or functionality embedded in commercially available software, such as EXCEL or VISUAL BASIC. Additionally, the software can be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

### EXAMPLES

### Example 1

### Comparison of Cancer Receptor Antagonists

In one application of the invention, CSMs are compared to define the underlying mechanisms for efficacy of a drug class, to identity on target (e.g., efficacy) and off target (e.g., side effects) aspects of that class, and to assess each drug in the class against those on-target and off-target aspects. In this Example, CSMs modeling activated networks elicited by three drug candidates for the treatment of cancer are compared. The drug candidates are referred to as Receptor Antagonist 1, Receptor Antagonist 2, and Receptor Antagonist 3. The CSMs for each, graphically illustrated in FIGS. 17B-17D respectively, include transcriptional data obtained from wet chemistry experiments with each drug candidate as well as information known in the scientific community. Each CSM includes thousands of nodes.

In addition, in this Example, the three CSMs are used to generate a “general” CSM, and the on-target (shared by all three CSMs) and off-target (not shared by all three) nodes are identified. The off-target nodes in two CSMs are reviewed to suggest a candidate for further investigation or development.

1A. Defining a Mechanism of Action for a group of Receptor Antagonists

Using the methods described herein for generation of CSMs, a general CSM of cancer is generated, as graphically illustrated in FIG. 17A. This general CSM is developed using data known in the scientific community and/or experimentally empirical data, for example, changes in gene expression, protein abundance, and/or protein phosphorylation in one or more cancer cell lines as compared to corresponding healthy or homeostatic cell lines.

The cancer cell lines from which the CSM is developed are treated with each of the three Receptor Antagonist drug candidates. Changes in gene transcription are measured in the cancer cell lines exposed to each Receptor Antagonist vs. untreated cancer cells, to generate a unique CSM for the biological effects associated with each drug candidate representing differences in biological networks activated by each drug candidate. It is understood that changes in other biological entities, actions, and/or functional activities can be measured, for example, changes in protein presence, protein abundance, and/or protein modifications, such as phosphorylation. As graphically illustrated in FIGS. 17B-17D, the CSM for the biological effects associated with each drug candidate is mapped as a network against a backdrop of the cancer CSM. It should be appreciated that such graphical illustrations are for explanatory purposes only and that CSMs are probed and mined computationally.

The CSMs representing the biological effects associated with each drug candidate then are compared. The union or intersection of the three CSMs, each modeling a biological network activated by a Receptor Antagonist, can also be mapped onto the general cancer CSM, as graphically illustrated in FIGS. 18A and 18B, respectively. The union of the three CSMs combines all of the biological network pathways (i.e., nodes and links) activated by the three Receptor Antagonists to yield the complete collection of biological network pathways activated by the group of drug candidates. In the union, some network pathways are activated by only one of the three drug candidates and appear in only one of the individual CSMs. Some network pathways are activated by two of the three drug candidates (as graphically illustrated in FIG. 18A). Some network pathways are activated by all three drug candidates.

The intersection of the three CSMs combines the common biological network pathways activated by all three Receptor Antagonist drug candidates, as graphically illustrated in FIG. 18B. If each drug candidate is known to be efficacious, then the activated network pathways common to all three CSMs include a mechanism of action for each Receptor Antagonist and for the class of Receptor Antagonists tested. That is, if each compound is efficacious, the group of activated network pathways common to all three comprises the mechanism of action for each compound and for the compound class.

### 1B. Defining Key On-Target and Off-Target Mechanisms

The intersection of the three CSMs can itself be viewed as a CSM, for example, as a general CSM describing the mechanism of action or biological effects shared by all Receptor Antagonists tested. Nodes shared by all three of the CSMs, which appear in the general CSM of shared biological effects, can be identified as key on-target mechanisms that are, at least hypothetically, inexorably associated with a desired modulation of a particular target molecule. Limiting criteria can be used to further limit nodes representing “key” on-target mechanisms.

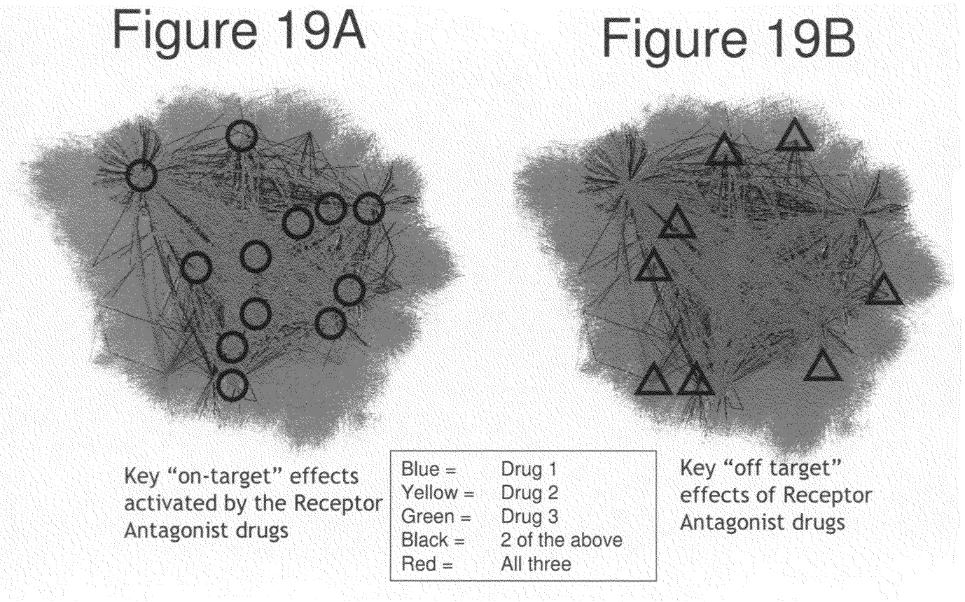

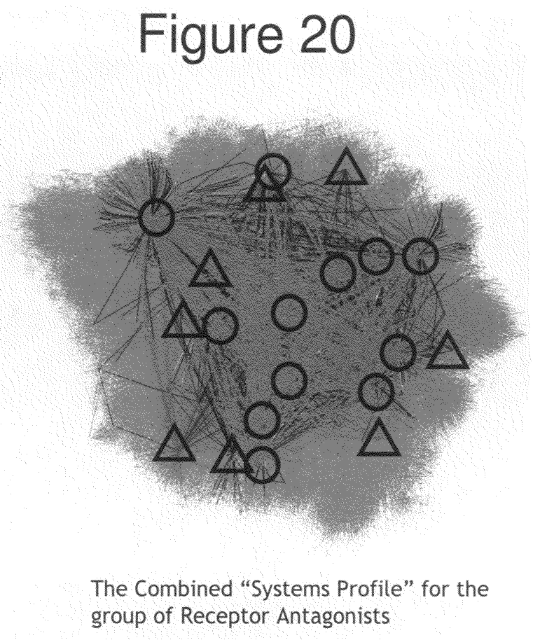

Nodes representing key on-target mechanisms are identified by circles as illustrated in FIG. 19A. Nodes that appear in only one or two CSMs associated with individual drug candidates, which do not appear in the general CSM of the intersection of shared biological effects, are identified as off-target mechanisms that are unrelated or not necessarily associated with a desired modulation of a particular target molecule. Limiting criteria can be used to further limit nodes representing off-target mechanisms. Nodes representing off-target mechanisms are identified by triangles as illustrated in FIG. 19B. FIG. 20 depicts the combined systems profile of the key on-target mechanisms for Receptor Antagonism (circles) and the off-target biological effects elicited by one or more of the Receptor Antagonists (triangles).

The general CSM of Receptor Antagonism is compared with two of the individual CSMs associated with Receptor Antagonist 1 and Receptor Antagonist 2, respectively, as illustrated in FIGS. 21A and 21B. This comparison identifies off-target mechanisms elicited for the respective drug candidates. For example, the triangles identified by arrows in FIGS. 21A and 21B identify exemplary off-target mechanisms elicited by Receptor Antagonist 1 and Receptor Antagonist 2, respectively. The information obtained from this analysis can be used to suggest which of three drug candidates may be the best candidate for further development.

This application of the invention can identify the molecular mechanisms that lead to drug efficacy for Receptor Antagonist 1, Receptor Antagonist 2, Receptor Antagonist 3, as well as this group of Receptor Antagonists. By combining the CSMs, each modeling a biological network activated by a Receptor Antagonist, the common, intersecting, biological mechanisms (on-target mechanisms) are identified and a general CSM depicting these common features is generated. This comparison generally corresponds to an Eff_{ME} CSM being compared with another Eff_{ME} CSM (C vs. C), as described above, and common mechanisms between the CSMs identify on-target mechanisms for a therapeutic use. However, it is understood that this same approach can be used to conduct a comparison of a Tox_{ME} CSM with another Tox_{ME} CSM (B vs. B), a Tox_{ME} CSM with an Eff_{ME} CSM (B vs. C) or any comparison of CSMs. For example, two or more drugs with similar toxicities can be compared to identify the underlying biology of common toxic mechanisms or to identify one of many drugs that has the fewest toxicities in common with the others.

It is understood that a general CSM does not need to be generated to compare individual CSMs with commonalities found in a group of CSMs. Specifically, using computational methods, many CSMs can be compared to each other and to commonalities shared by the group (e.g., common or similar nodes, or groups of the same) in parallel processes or in a single step process, without the need to generate a general CSM.

In addition, comparison of each CSM representing a biological network activated by a particular Receptor Antagonist with the general CSM yields understanding of how well each Antagonist fits the efficacy model in terms of both key on-target mechanisms and off-target mechanisms. Similar comparisons of a general CSM with a specific CSM generally follow a Tox_{GEN} CSM vs. Tox_{ME} CSM (A vs. B) or Tox_{GEN} CSM vs. Eff_{ME} CSM (A vs. C) comparison, as described above. Comparisons of any CSMs can be performed in a similar fashion as described in this example.

By identifying the off-target effects for Receptor Antagonist 1 and Receptor Antagonist 2, key risk factors for these drugs are identified. Since the mechanisms sufficient for efficacy (on-target mechanisms) are also elucidated, causal connections between efficacy and risk factors can be identified as connections between nodes representing on-target and off-target mechanisms. It is appreciated that the off-target effects also can be evaluated against a library of CSMs to evaluate the implications of the specific networks activated.

Accordingly, this application of the invention can aid in the identification of a lead drug candidate among a group of candidate drugs, for example, by identifying biological networks for efficacy or toxicity that tested drug candidates can be screened against.

### Example 2

### Safety Assessment of Four Related Compounds to Treat a Disease

The following Example describes a safety assessment of a lead compound (Compound 1) among a group of four structurally related compounds, identified as Compounds 1-4. Possible side effects are identified for the lead compound as compared to a second compound in the group.

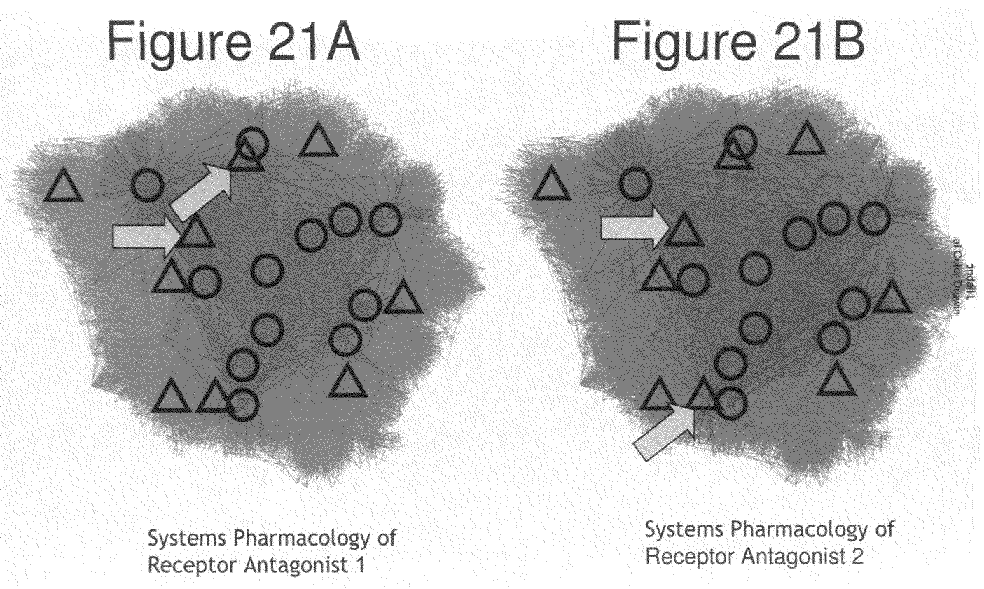

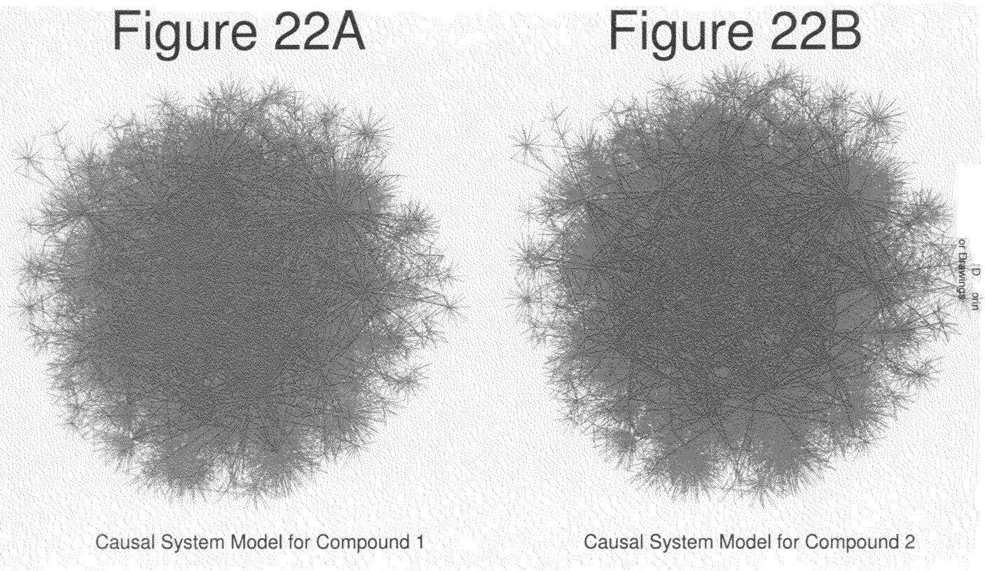

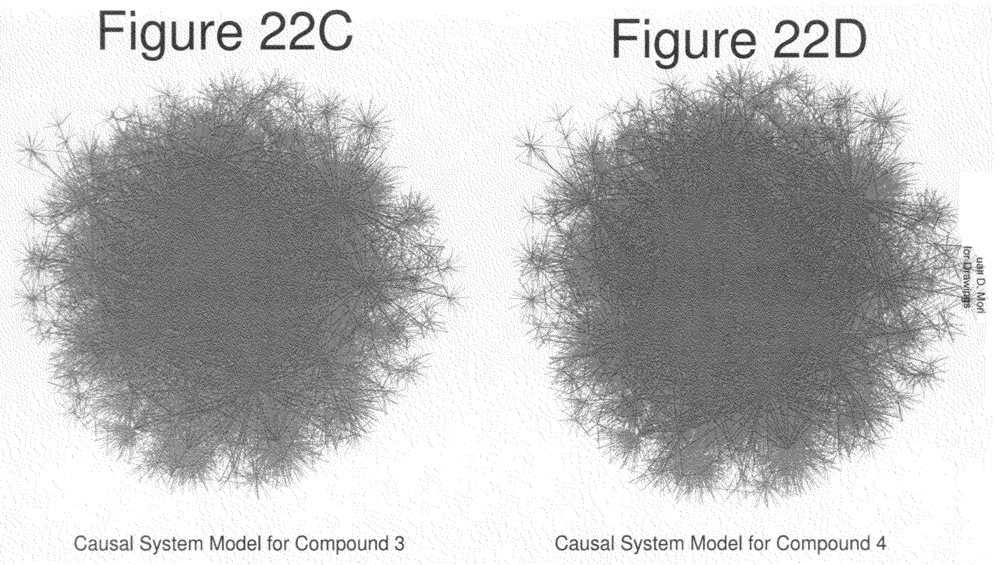

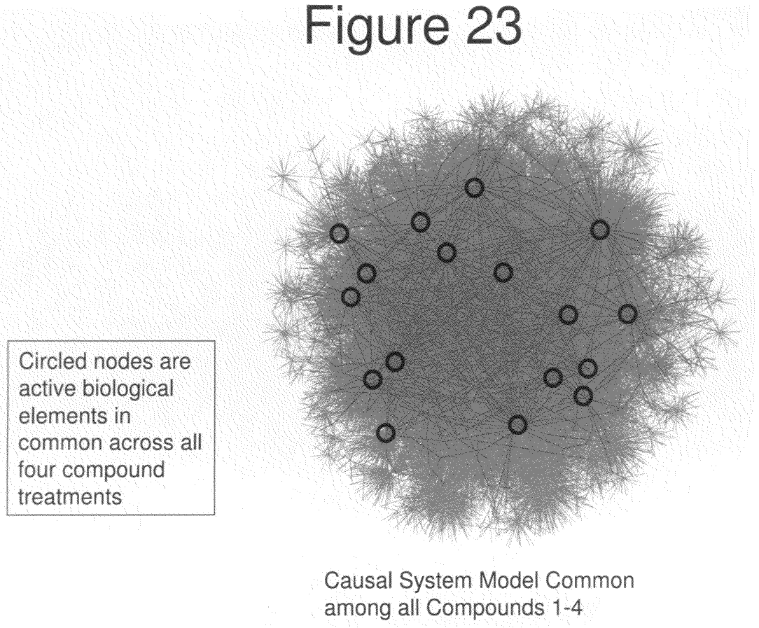

To assess the safety of Compound 1, CSMs of the biological effects associated with Compound 1, as well as the three structurally-related compounds, Compounds 2-4, are prepared according to methods described above. The CSM for each of these compounds is illustrated in FIGS. 22A-22D. The CSMs are then compared and a general CSM of the biological effects common to all compounds is prepared, as illustrated in FIG. 23. Circled nodes in FIG. 23 represent active biological elements in common across all four compounds tested.

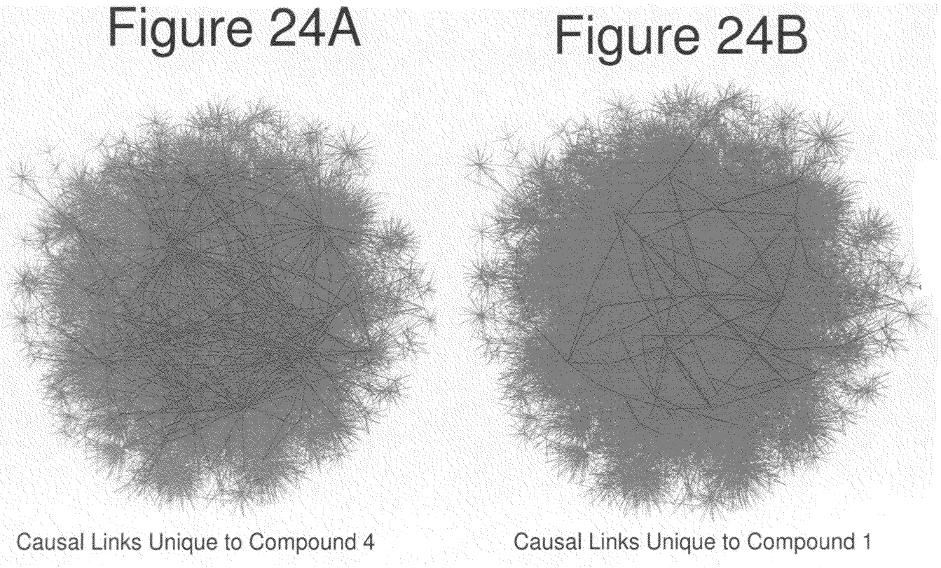

The CSM of the biological effects associated with Compound 1 is then compared with the general CSM of the biological effects common to all four compounds to identify causal links unique to Compound 1 that may represent undesired off-target biological effects. The resulting comparison is illustrated in FIG. 24B. For reference, the result of a similar comparison between the Compound 4 CSM and the general CSM is illustrated in FIG. 24A. As indicated by FIG. 24B, Compound 1 shows relatively few unique causal links (not shared with all other compounds tested) that may represent undesired off-target biological effects.

This application exemplifies the use of the present invention to assess risks of molecular entities and identify potential target biological elements, based upon observing perturbations to CSMs of a biological system representing administration of four molecular entities to the biological system. The individual CSMs associated with those molecular entities are subsequently compared and a general CSM is generated from this comparison. The general CSM is then compared against select individual CSMs to identify causal links unique to the respective molecular entities, which may represent undesired off-target biological effects. These data can be used to suggest a molecular entity for further development among a group of potential candidates.

As noted above, the individual CSMs are generated from empirically observed data, but other knowledge can also be used to generate these or any CSMs. Accordingly, the generation and comparison of CSMs can be employ a semi-automated knowledge driven approach and can support large-scale assessment of potential safety issues (e.g., this approach can be readily applied across targets, molecular entities, classes of molecular entities, and/or toxicities, at very large scale). Moreover, identified toxicities can be evaluated and refined to generate general toxicity CSMs (e.g., Tox_{GEN} CSMs), which can include both mechanism and non-mechanism based toxicities.

### INCORPORATION BY REFERENCE

The entire disclosure of each of the publications and patent documents referred to herein is incorporated by reference in its entirety for all purposes to the same extent as if each individual publication or patent document were so individually denoted.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

1. A software assisted method for identifying similarities and differences between the biochemistry of a plurality of biological states, the method comprising the steps of:
a) providing in a storage medium a plurality of causal system models, each model representing a biological state in an animal, and comprising:
(i) nodes representative of differences in plural biological entities, actions, functional activities, or concepts in a said biological state as compared with a second biological state, and
(ii) links between nodes indicative of there being a causal directionality therebetween; and
b) comparing electronically at least a portion of at least one causal system model to at least a portion of at least one other casual system model to identify similarities and differences between nodes from respective said models thereby to discern biochemical similarities and differences between said modeled biological states; and
c) causing an electronic representation of said biochemical similarities and differences between said modeled biological states to be physically stored on a computer-readable medium.

2. The method of claim 1 comprising comparing one causal system model to plural other causal system models to discern the underlying biochemical network characteristic of the biological state represented by said one causal system model.

3. The method of claim 1 wherein the modeled biological states are selected from the group consisting of a disease biological state, a biological state at disease onset, a biological state at disease progression, a biological state at disease regression, a toxic biological state, a drug-treated biological state, a therapy-treated biological state, a drug- or therapy-sensitive biological state, and a drug- or therapy-resistant biological state.

4. The method of claim 1 comprising the additional step of suggesting a biological experiment to assess the biological reality of a said similarity or difference between said modeled biological states.

5. A software assisted method for probing pharmacology in an animal, the method comprising the steps of:
a) providing in a storage medium a plurality of causal system models,
each model comprising a collection of nodes representative of differences in plural biological entities, actions, functional activities, or concepts in a said biological state as compared with a second biological state, and links between nodes indicative of there being a causal directionality therebetween,
each model being representative of the biochemistry of an animal induced by administration to the animal of a selected molecular entity, a selected dose of a selected molecular entity, or a selected group of molecular entities;
b) comparing electronically at least portions of at least two said causal system models to discern biochemical differences between the biochemical effects in the animal of different molecular entities, different doses of molecular entity, or different groups of molecular entities; and
c) causing an electronic representation of the biochemical differences between the biochemical effects in the animal of different molecular entities, different doses of molecular entity, or different groups of molecular entities to be physically stored on a computer-readable medium.

6. The method of claim 5 comprising the additional step of suggesting a molecular entity for development.

7. The method of claim 5 comprising probing the efficacy of a molecular entity to induce a desired biological effect by comparing a causal system model of the biochemical effects of administration of the entity to a causal system model of the biochemical effects of one or more different molecular entities which induce the same or a related biological effect.

8. The method of claim 5 comprising probing the toxicology of a molecular entity by comparing causal system models of the biochemical effects of administration of a plurality of different molecular entities directed to the same target.

9. The method of claim 5 comprising probing the toxicology of a molecular entity by comparing a causal system model of the effects of administration to a mammal of said molecular entity to plural causal system models of toxic responses.

10. The method of claim 5 comprising probing the toxic effect associated with agonizing or antagonizing a preselected target by comparing a causal system model of the biological effect of agonizing or antagonizing said target to a causal system model of a toxicity.

11. The method of claim 6 comprising conducting a biological experiment with a suggested molecular entity.

12. The method of claim 5 comprising probing the toxic effect associated with agonizing or antagonizing a preselected target by comparing a causal system model of the biological effect of agonizing or antagonizing the target with a molecular entity to a causal system model of the biological effects of a different molecular entity known to have a toxicity.

13. The method of claim 5 wherein said provided plurality of causal system models comprise models of toxicities generated from data descriptive of the biochemistry of toxicities relating to the function of the heart, liver, kidney, nervous system, circulatory system, respiratory system, or immune system.

14. The method of claim 5 wherein the compared causal system models are models generated from data from different species.

15. The method of claim 5 wherein said pharmacology is a toxic state or a drug-induced state.

16. The method of claim 5 wherein the provided models are generated by a method comprising the steps of:
providing a knowledge base of biological assertions concerning a selected biological state, the knowledge base comprising a network of a multiplicity of nodes representative of biological entities, actions, functional activities, and concepts, and links between nodes indicative of there being a relationship between the nodes, wherein at least some of the links comprise indicia of causal directionality;
simulating in the network one or more perturbations of plural individual root nodes to initiate a cascade of virtual activity through said links between connected nodes to discern multiple branching paths within the knowledge base;
mapping onto the knowledge base operational data representative of a perturbation, associated with a biological state, of one or more nodes and optionally of experimentally observed or hypothesized changes in other nodes resulting from the one or more perturbations;
prioritizing said branching paths on the basis of how well they predict said operational data, thereby to define a set of models comprising said branching paths potentially explanatory of the molecular biology implied by the data;
applying logic based criteria to said set of models to reject models as not likely representative of real biology thereby to eliminate hypotheses and to identify from remaining models one or more causative relationships.

17. The method of claim 15 comprising the additional step of harmonizing a plurality of said remaining models to produce a larger model comprising a model of at least a portion of the operation of said biological system.

18. The method of claim 15 wherein a said logic based criterion is based on a measure of consistency between:
the predictions resulting from simulation along multiple nodes of a model and known biology of said selected biological system;
the operational data and the predictions resulting from simulation within a model upstream from a root node to a node corresponding to an operational data point;
the operational data and the predictions resulting from simulation within a model downstream from a root node to a node corresponding to an operational data point.

19. A method for discovery by an investigator of similarities and differences between the biochemistry of a plurality of biological states, the method comprising the steps of causing a second party entity or entities to:
a) provide in a storage medium a plurality of causal system models, each model representing a biological state in an animal, and comprising:
(i) nodes representative of differences in plural biological entities, actions, functional activities, or concepts in a said biological state as compared with a second biological state, and
(ii) links between nodes indicative of there being a causal directionality therebetween; and
b) compare electronically at least a portion of at least one causal system model to at least a portion of at least one other casual system model to identify similarities and differences between nodes from respective said models thereby to discern biochemical similarities and differences between said modeled biological states; and
c) cause an electronic representation of said biochemical similarities and differences between said modeled biological states to be physically stored on a computer-readable medium.

20. A method for probing by an investigator pharmacology in an animal, the method comprising the steps of causing a second party entity or entities to:
a) provide in a storage medium a plurality of causal system models,
each model comprising a collection of nodes representative of differences in plural biological entities, actions, functional activities, or concepts in a said biological state as compared with a second biological state, and links between nodes indicative of there being a causal directionality therebetween,
each model being representative of the biochemistry of an animal induced by administration to the animal of a selected molecular entity, a selected dose of a selected molecular entity, or a selected group of molecular entities;
b) compare electronically at least portions of at least two said causal system models to discern biochemical differences between the biochemical effects in the animal of different molecular entities, different doses of molecular entity, or different groups of molecular entities; and
c) cause an electronic representation of the biochemical differences between the biochemical effects in the animal of different molecular entities, different doses of molecular entity, or different groups of molecular entities to be physically stored on a computer-readable medium.

21. The method of claim 19 wherein said investigator is a pharmaceutical company and a said second entity is a discovery unit associated with the pharmaceutical company or an outside contractor.
